(19) United States
(12) Patent Application Publication
(10) Pub. No.: US 2024/0047804 A1
(43) Pub. Date: Feb. 8, 2024

(54) BATTERY PACK AND VEHICLE

(71) Applicant: HONDA MOTOR CO., LTD., Tokyo (JP)

(72) Inventor: Chuyun Guo, Guangdong (CN)

(21) Appl. No.: 18/226,799

(22) Filed: Jul. 27, 2023

(30) Foreign Application Priority Data
Aug. 4, 2022 (CN) 202210931445.6

(51) Int. Cl. H01M 50/242; H01M 10/42; B60L 50/64; H01M 10/613; H01M 10/6568; H01M 10/625; H01M 50/209

(52) U.S. Cl. CPC H01M 50/242; H01M 10/425; B60L 50/64; H01M 10/613; H01M 10/6568; H01M 10/625; H01M 50/209; H01M 2220/20

(57) ABSTRACT

A battery pack and a vehicle with the battery pack that can improve safety are provided in the present invention. The battery pack includes a housing, which includes a base plate provided with a holding portion; a battery module arranged above the base plate; and an electrical connection component, which is electrically connected with the battery module and is accommodated in the holding portion. In this way, for example, when the vehicle is impacted, the risk of the battery module moving and thereby impacting or squeezing the electrical connection components can be suppressed, and the safety of the battery pack and the vehicle can be improved.

### CROSS-REFERENCE TO RELATED APPLICATION

Priority is claimed on Chinese Patent Application No. 202210931445.6, filed on Aug. 4, 2022, the contents of which are incorporated herein by reference.

### BACKGROUND OF THE INVENTION

### Field of the Invention

The present invention relates to a battery pack and a vehicle.

### Description of Related Art

For example, in the battery pack of an electric vehicle, there is an electrical connection component that is electrically connected to the battery modules, and is used for transmitting electrical energy or signals. Currently, there is a battery pack structure in which the electrical connection component is configured in a gap between the battery modules inside the battery pack, thereby reducing the size of the battery pack.

However, when an electric vehicle crashes, for example, the battery pack may deform, causing the battery modules to move, thereby hitting or crushing the electrical connection component located in the gap, which adversely affects the safety of the battery.

### SUMMARY OF THE INVENTION

The present invention provides a battery pack and a vehicle capable of improving safety.

The first aspect of the present invention provides a battery pack comprising: a housing, which comprises a base plate, said base plate being provided with a holding portion; a battery module, which is arranged above said base plate; and an electrical connection component, which is electrically connected to said battery module and is housed in said holding portion. It is understood that the up and down directions are the directions along which the base plate and the battery module overlap.

With the above structure, the electrical connection component is housed in the holding portion provided in the base plate, and thus, for example, when the battery pack is moved by a collision, the electric connection component can be protected by the holding portion so that the battery pack does not easily hit the electric connection component. Thereby, problems such as damage to the electrical connection component or damage to the electrical connection (including poor contact or electrical connection failure) can be suppressed, improving safety of the battery pack.

In addition, by providing the electrical connection component in the holding portion of the base plate, it is possible to lower the height position of the electrical connection component. It is also possible to reduce a dimension in the height direction of the housing as a whole, i.e., it is possible to reduce a dimension in the height direction of the battery pack and to miniaturize the battery pack.

As a possible embodiment of the first aspect, said electrical connection component is partially or entirely located below the horizontal plane where the lowest point of said battery module is located.

With the above structure, when the battery module moves along the base plate or rotates with the bending of the base plate, the battery module is less likely to hit the electrical connection component because the electrical connection component is partially or entirely below the horizontal plane where the lowest point of the battery module is located, so that the safety of the battery pack can be reliably improved.

As a possible implementation of the first aspect, the base plate is equipped with a coolant channel.

With such a structure, since the base plate is equipped with a coolant channel, the base plate needs to have a certain thickness to set the coolant channel. Using such a base plate to set the holding portion to accommodate the electrical connection component makes the thickness of the base plate less likely to increase, which is conducive to the miniaturization of the battery pack.

In addition, the holding portion and the coolant channel are both arranged in the base plate to fully utilize the space of the base plate, making the structure of the battery pack more compact.

Furthermore, the holding portion and the coolant channel are both arranged in the base plate, so that the battery module and the electrical connection component can be easily cooled simultaneously by the coolant. As a possible implementation of the first aspect, the holding portion and the coolant channel are arranged in the extension direction of the base plate, and their height positions overlap (i.e., they are arranged in approximately the same height range in the up and down directions).

As a possible implementation of the first aspect, in the base plate, the coolant channel is arranged at a position that coincides with the battery module when viewed in the up and down directions, and the holding portion is arranged at a position that is staggered from the battery module.

With the above structure, the holding portion is arranged at a staggered position from the battery module, thereby avoiding affecting the cooling effect of the battery module.

As a possible implementation of the first aspect, the electrical connection component comprises a high-voltage connection component.

With the above structure, the high-voltage connection component is contained in the holding portion, which can suppress the occurrence of problems such as damage, leakage or electrical connection damage of the high-voltage connection component caused by the impact of the battery module, and improve the safety of the battery pack. In addition, when the holding portion is arranged at the position staggered from the battery module, the holding portion should be as far away from the battery module as possible so that, for example, electromagnetic waves generated by the high-voltage connection component can be suppressed from interfering with the battery module.

As a possible implementation of the first aspect, the high-voltage connection component comprises a high-voltage harness, which is flat in a cross section and is contained in the holding portion such that its thickness direction is roughly consistent with the thickness direction of the base plate.

In this way, for example, compared to using a circular or flat wire harness with a thickness direction perpendicular to the thickness direction of the base plate, it can be ensured that the high-voltage harness can effectively transmit electrical energy, and minimize the height of the high-voltage harness as much as possible, thereby effectively suppressing the occurrence of the high-voltage harness being hit by the battery module and improving the safety of the battery pack.

As a possible implementation of the first aspect, the high-voltage connection component is in a long shape, extending from one end of the base plate to the other end.

In this way, the strength of the base plate in the front and back directions can be improved, solving the problem of reduced strength caused by the installation of the holding portion of the base plate.

As a possible implementation of the first aspect, the high-voltage connection component comprises a high-voltage harness and a high-voltage harness bracket, the base plate is provided with an opening, the high-voltage harness bracket is covered on the opening, forming the top of the holding portion, and the high-voltage harness is arranged below the high-voltage harness bracket.

With this structure, during assembly, the high-voltage harness can be installed on the high-voltage harness bracket first, and then the high-voltage harness bracket with the high-voltage harness can be installed on the base plate. In this way, it is easy to install and position the high-voltage harness.

As a possible implementation of the first aspect, the lowest point of the high-voltage harness bracket is located on a horizontal plane that is roughly flush with or below the upper surface of the base plate.

In this way, it is possible to reliably suppress the occurrence of the problem that the battery module collides with or squeezes into the high-voltage connection component and the high-voltage harness therein when moving.

As a possible implementation of the first aspect, the high-voltage harness comprises a cladding layer and a conductive component arranged within the cladding layer, and the cladding layer is fixed on the high-voltage harness bracket.

With the above structure, the cladding layer can ensure the insulation of the conductive component and fix the conductive component on the high-voltage harness bracket.

As a possible implementation of the first aspect, the battery pack also comprises a low-voltage connection component electrically connected with the battery module, and the low-voltage connection component is arranged above the high-voltage harness bracket.

In this way, the low-voltage connection component can be configured close to the high-voltage connection component, making the structure compact, effectively using space, and improving the space utilization efficiency in the battery pack.

As a possible implementation of the first aspect, a reinforcing member is provided above the base plate.

With the above structure, the reinforcing member is arranged above the base plate, so as to prevent the reinforcing member from affecting the electrical connection component contained in the holding portion.

As a possible implementation of the first aspect, the holding portion is in the shape of a long groove or a long hole, and extends across the reinforcing member.

As a possible implementation of the first aspect, the portion of the coolant channel that is farther from the centerline of the base plate is located upstream along the liquid flow, and the portion that is closer to the centerline of the base plate is located downstream along the liquid flow, wherein the centerline extends in the extension direction of the base plate.

Adopting the above structure, as the outer part of the battery module is more susceptible to external influences, in this embodiment, cooling the outer part first can effectively cool the battery module.

As a possible implementation of the first aspect, the battery module comprises multiple first battery modules and multiple second battery modules, wherein the multiple first battery modules are arranged in the first direction in a horizontal plane, the multiple second battery modules are arranged in the first direction, and both of the multiple first battery modules and the multiple second battery modules are arranged with gaps in the second direction in the horizontal plane. The second direction intersects with the first direction, and the holding portion is arranged at a position facing the gaps.

In this way, the holding portion is arranged in the middle position of the second direction of the base plate (such as the left and right directions in the embodiment), which can reduce the impact force on the high-voltage harness during collision and suppress damage to the high-voltage harness, when compared to the holding portion being located near the outer part of the base plate.

As a possible implementation of the first aspect, the holding portion comprises a cavity provided within the base plate, or an opening formed on an upper or lower surface of the base plate.

With the above structure, the electrical connection component can be disassembled or maintained through the opening on the upper surface or the lower surface of the base plate, which is convenient for disassembly or maintenance.

As a possible implementation of the first aspect, the base plate comprises a first board and a second board, wherein the first board is located above the second board, and configured relative to and separated from the second board, and the opening is arranged on the first board or the second board.

Adopting the above structure, the first board is separated from the second board by a space, and the space between the two is used to form the holding portion, thereby making the structure simple.

As a possible implementation of the first aspect, the holding portion further comprises a partitioning wall extending from one edge of the opening and extending from one of the first and second plates to the other.

With the above structure, when the base plate is subjected to external forces in the up and down directions, the partitioning wall can contact the other of the first and second plates, thereby improving the strength of the base plate.

As a possible implementation of the first aspect, the partitioning wall comprises a first partitioning wall and a second partitioning wall, wherein the first partitioning wall and the second partitioning wall are arranged at the edges of both sides of the opening, and the holding portion also has a bottom wall, which is connected between the first partitioning wall and the second partitioning wall.

With the above structure, the holding portion is seen as a groove from the side with an opening, and as a protrusion from the side without an opening, forming a reinforcing rib structure on the first or second plate, thereby improving the strength of the first or second plate and the base plate.

As a possible implementation of the first aspect, the bottom wall is in contact with or separated from the other of the first and second plates.

When the bottom wall is set to contact the other of the first and second plates, the strength of the base plate can be reliably improved.

The second aspect of the present invention provides a vehicle comprising a battery pack of any structure in the first aspect.

The vehicle from the second aspect can achieve the same technical effects as the first aspect, and the description will not be repeated here.

### BRIEF DESCRIPTION OF THE DRAWINGS

The various features of the present invention and the connection between the various features are further described below with reference to the accompanying drawings. The accompanying drawings are exemplary, some features are not shown to actual scale, and some of the accompanying drawings may omit features that are customary in the field covered by this application and are not essential to this application, or additionally show features that are not essential to this application. The combination of features shown is not intended to limit the present application. In addition, throughout this specification, the same appended markings are the same. The specific accompanying drawings are illustrated as follows:

FIG. 1 is a schematic diagram of a vehicle involved in an embodiment of the present invention;

FIG. 2 is a schematic diagram of the principle of a battery pack involved in an embodiment of the present invention;

FIG. 3 is a schematic diagram of a structure of a battery pack involved in an embodiment of the present invention;

FIG. 4 is a schematic diagram of a structure of a battery pack involved in an embodiment of the present invention;

FIG. 5 is a schematic diagram of the three-dimensional structure of the battery pack of FIG. 4 in a state with the top cover removed;

FIG. 6 is a schematic diagram of the structure of the battery pack of FIG. 4 in a top view with the top cover removed;

FIG. 7 is a schematic diagram of part of the structure of the housing of the battery pack in FIG. 4;

FIG. 8 is a schematic diagram of the structure in FIG. 7 in a state with the high-voltage harness removed;

FIG. 9 is a schematic diagram of the structure of the high-voltage harness involved in one embodiment of the present invention;

FIG. 10 is a schematic diagram of the three-dimensional structure of the reinforcing member involved in an embodiment of the present invention;

FIG. 11 is a cross-sectional schematic diagram of the structure in FIG. 6;

FIG. 12 is a partially enlarged view of the structure in FIG. 11;

FIG. 13 is another cross-sectional schematic diagram of the structure in FIG. 6;

FIG. 14 is a partially enlarged view of the structure in FIG. 13;

FIG. 15a is another partially enlarged view of the structure in FIG. 13;

FIG. 15b is a partial cross-sectional schematic diagram of the base plate in FIG. 15a;

FIG. 16 is a schematic diagram of the combined state of the low-voltage connection component and the control device and its peripheral structures involved in one embodiment of the present invention;

FIG. 17 is a schematic diagram of the structure in FIG. 16 in a disassembled state;

FIG. 18 is a schematic diagram of the combined state of the low-voltage connection component involved in an embodiment of the present invention;

FIG. 19 is a schematic diagram of the structure in FIG. 18 in a disassembled state;

FIG. 20 is a partially enlarged view of the structure in FIG. 18;

FIG. 21a is a schematic diagram of the structure of the combined state of the high-voltage harness bracket and the control device bracket involved in one embodiment of the present invention;

FIG. 21b is a partially enlarged view of the structure illustrated in FIG. 21a;

FIG. 21c is another partially enlarged view of the structure illustrated in FIG. 21a;

FIG. 21d is another partial enlargement of the structure illustrated in FIG. 21a;

FIG. 22a is a diagram of the combined state of the battery module, the power distribution device bracket and the power distribution device involved in one embodiment of the present invention;

FIG. 22b is a schematic top view of the structure in FIG. 22a;

FIG. 23 is a structural schematic diagram of the structure of FIG. 22a in a disassembled state;

FIG. 24 is a schematic diagram of the three-dimensional structure of the power distribution device bracket involved in one embodiment of the present invention;

FIG. 25 is a schematic diagram of the three-dimensional structure of a battery module involved in an embodiment of the present invention;

FIG. 26 is a schematic diagram of the three-dimensional structure of the power distribution device involved in an embodiment of the present invention;

FIG. 27 is a schematic top view of the power distribution device involved in an embodiment of the present invention;

FIG. 28a is a schematic diagram of a three-dimensional structure of a control device in an embodiment of the present invention;

FIG. 28b is a schematic side view of the control device;

FIG. 28c is a schematic bottom view of the control device;

FIG. 28d is another schematic diagram of a three-dimensional structure of the control device;

FIG. 29 is a schematic diagram for illustrating the structure of the snap portion involved in an embodiment of the present invention;

FIG. 30 is a schematic diagram of the structure of a battery pack involved in an embodiment of the present invention, the structure of which differs from that of the embodiment illustrated in FIG. 4;

FIGS. 31a to 31f show some examples of a base plate and a holding portion in the base plate.

### BRIEF DESCRIPTION OF THE REFERENCE SYMBOLS

10, housing; 11, base plate; 11a, protrusion; 12, side plate; 13, upper cover; 14, lugs; 15, window plate; 16d, bolt; 16e, nut; 20, battery module; 20a, main part; 20b, mounting hole; 20c, wiring port; 20L, battery module; 20R, battery module; 21, bolt; 22, nut; 31, power distribution device; 31a, mounting hole; 31b, wiring terminal; 31c, wiring terminal; 31d, wiring terminal; 32, power distribution device bracket; 32a, mounting hole; 33, bolt; 34, nut; 41, control device; 42, control device bracket; 42a, main part; 42b, base part; 42c, harness fixing portion; 44, ring bracket; 50, high-voltage connection component (an example of the first high-voltage connection component, electrical connection component); 51, high-voltage harness (an example of a wire harness); 51a, conductive component; 51b, cladding layer; 51c, protrusion; 52, connector; 53, connector; 55, high-voltage connection component (an example of a second high-voltage connection component); 58, terminal block; 60, low-voltage connection component; 61, low-voltage harness (an example of a wire harness); 62, low-voltage harness bracket; 63, ring bracket; 64, ring bracket; 65, connector; 66, connector; 70, reinforcing component; 71, first connection component; 72, reinforcing member; 72a, arch portion; 72b, vertical portion; 72c, fixing portion; 72d, groove; 72e, opening; 73, second connection component; 100, battery pack; 101, connection port; 102, connection port; 111, plate; 112, high-voltage harness bracket; 112a, main part; 112b, raised part; 113, holding portion; 114, snap portion; 115, coolant channel; 116, plate; 116a, opening; 118, plate; 200, vehicle; 201, wheel; 202, wheel; 203, wheel; 204, wheel; 210, motor (an example of a first motor); 220, motor (an example of a second motor); 321, top part; 321a, reinforcing rib; 322, side part; 611, main wire portion; 612, branch wire portion; 621, main part; 623, wire harness fixing portion.

### DETAILED DESCRIPTION OF THE INVENTION

Some embodiments of the present invention are described in detail below with reference to the accompanying drawings. In the following description, the directions are defined in terms of the driver. However, these directions are defined for ease of description and are not limitations of the invention. In addition, these directions are also indicated in some of the accompanying drawings.

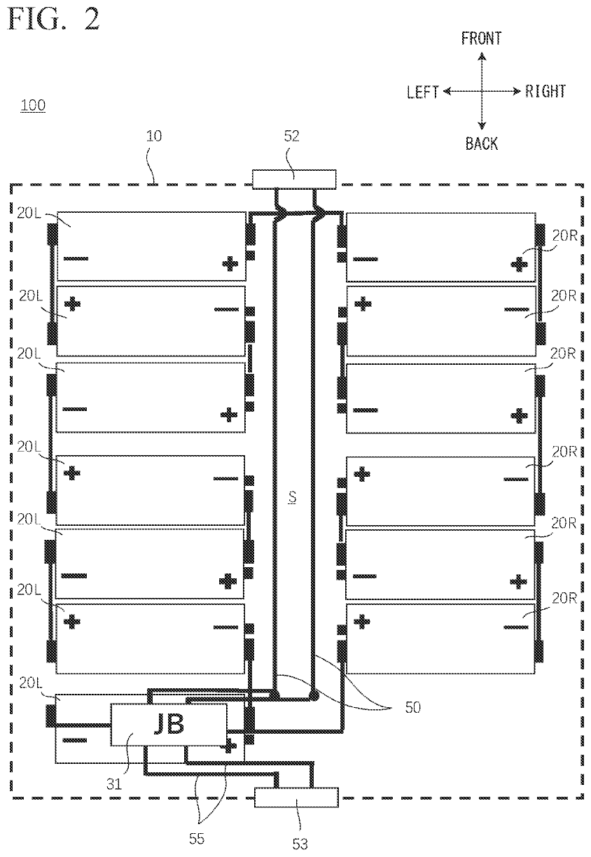

As shown in FIGS. 2 to 4, etc., embodiments of the present invention provide a battery pack 100 that comprises a housing 10, a battery module 20, and a high voltage connection component 50.

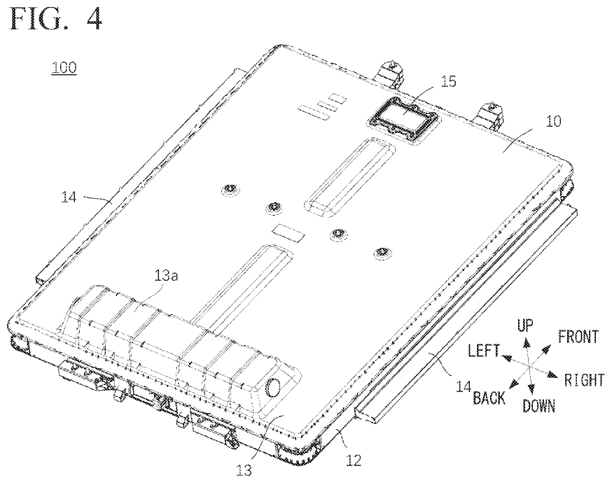

As shown in FIGS. 4 to 8, FIG. 12, etc., the housing 10 comprises a base plate 11, which is provided with a holding portion 113 for holding the high-voltage connection component.

Also, in the embodiment shown in FIGS. 4 to 8, FIG. 12, etc., the base plate 11 comprises a plate 111 (an example of a second plate) and a plate 116 (an example of a first plate). The plate 116 is located above the plate 111, and the holding portion 113 is provided between the plate 116 and the plate 111.

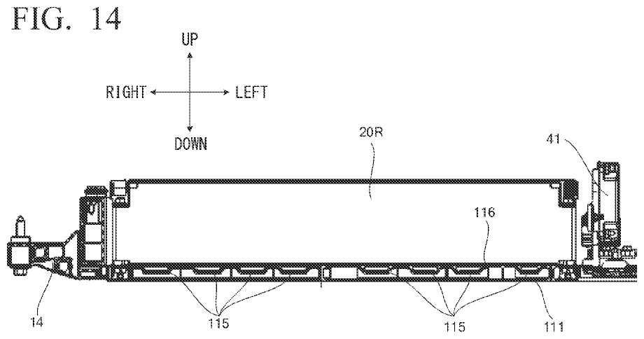

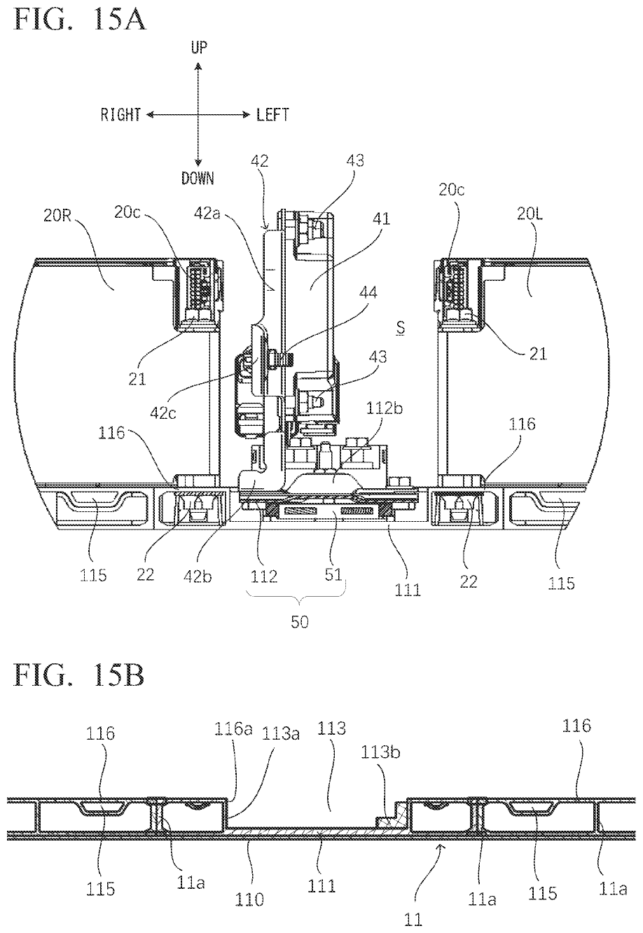

As shown in FIG. 14, FIG. 15a, etc., the battery module 20 is arranged on top of the base plate 11. For example, it is arranged above the plate 116.

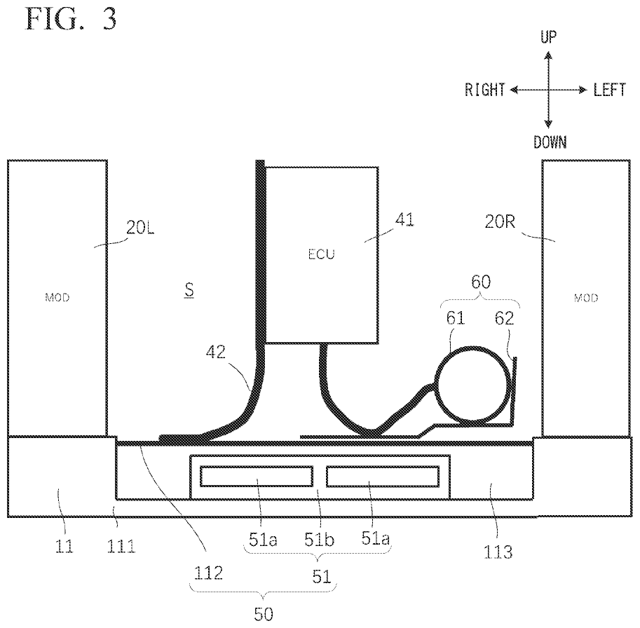

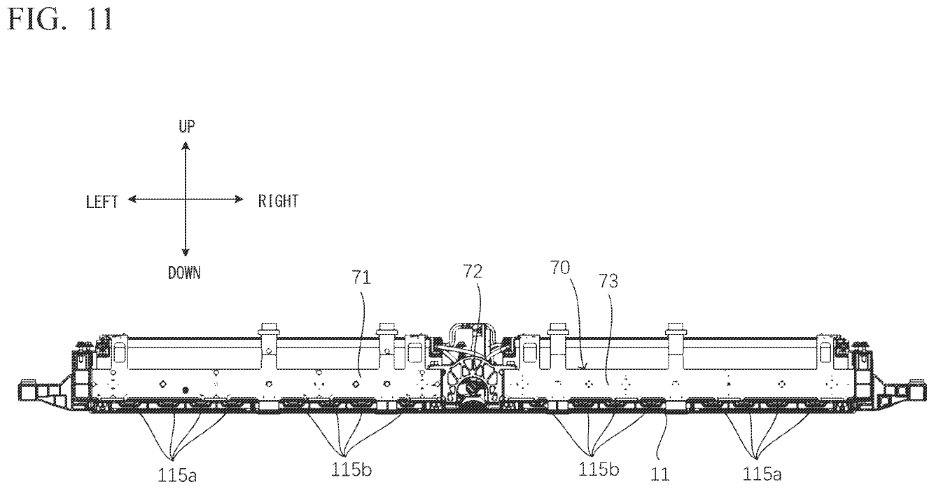

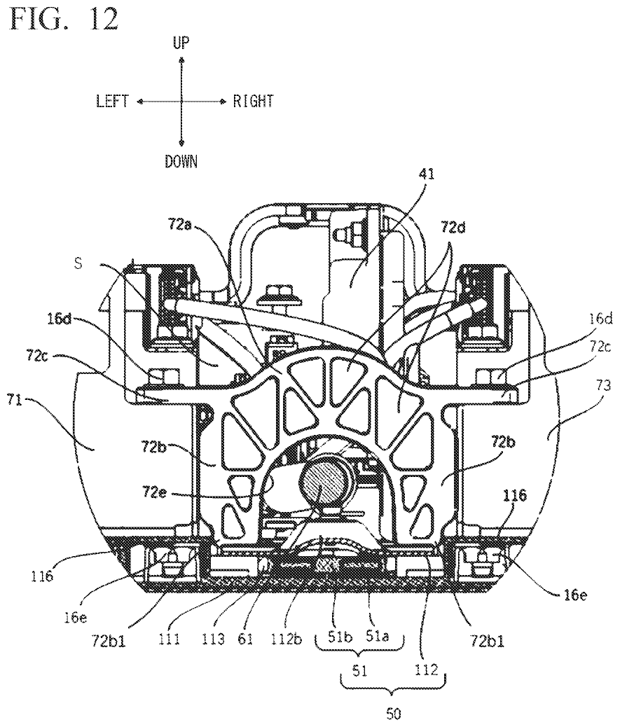

The high-voltage connection component 50 is electrically connected to the battery module 20 as described in FIG. 2, and in addition, as shown in FIG. 3, FIG. 12 and FIG. 15a, the high-voltage connection component 50 is contained in the holding portion 113.

With the above structure, for example, when the vehicle is subjected to a lateral collision, the battery pack 100 is deformed and the battery module 20 makes a displacement. However, since the high-voltage connection component 50 is configured in and protected by the holding portion 113 set in the base plate 11 under the battery pack 20, the moving battery pack 20 is not likely to hit the high-voltage connection component 50. This prevents deformation or breakage of the high-voltage connection component 50, and thus improves the safety and reliability of the battery pack 100.

In addition, a holding portion 113 for holding the high-voltage connection component 50 is configured in the base plate 11, and the high-voltage connection component 50 is configured in the base plate 11 so that the structure and space of the base plate 11 can be effectively used to facilitate miniaturization of the battery pack 100. For example, the height of the battery pack 100 (i.e., in the thickness direction of the base plate) can be reduced.

Optionally, the high-voltage connection component 50 may be partially or entirely located below the horizontal plane where the lowest point of the battery module 20 is located. Thus, for example, as the battery module 20 moves along the base plate 11, it is less likely to hit the high-voltage connection component 50 in the holding portion 113 in the base plate 11, thereby reliably improving the safety of the battery pack 100.

As other embodiments, a low-voltage connection component can also be accommodated in the holding portion 113. The low-voltage connection component is used to electrically connect the battery module. Both the low-voltage connection component and the high-voltage connection component 50 are electrical connection components in this application.

It will be appreciated that the housing 10 may include not only a base plate 11, but also side plates 12 extending from the peripheral edges of the base plate 11, and an upper cover 13 covering the space formed by the base plate 11 and the side plates 12. The battery module 20 is configured in the interior space of the housing 10 formed by the base plate 11, the side plates 12, and the top cover 13 together.

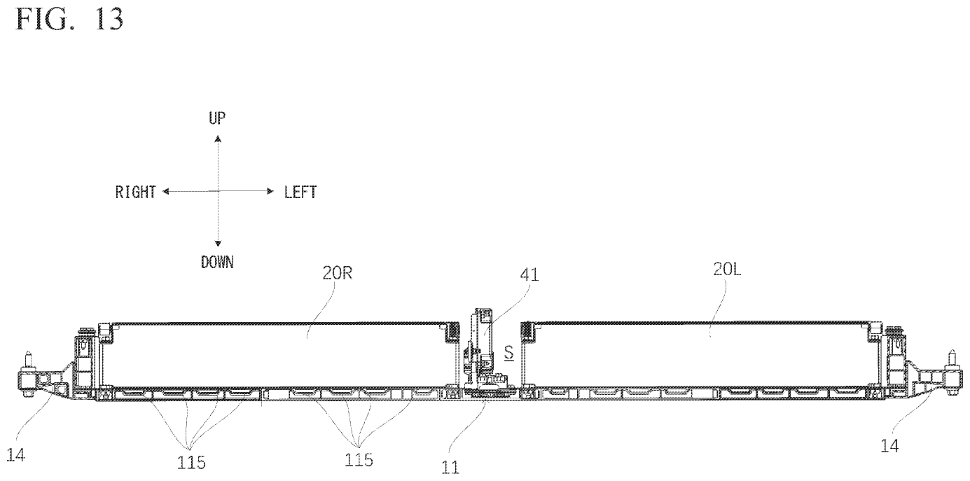

Optionally, as shown in FIG. 11, FIG. 13, and FIG. 14, as an embodiment, the base plate 11 is provided with a coolant channel 115.

With such a structure, the base plate 11 needs to have a certain thickness to provide the coolant channel 115 because the coolant channel 115 is provided in the base plate 11. In the embodiment of the present invention, such a base plate 11 is used to provide a holding portion 113 to hold the high-voltage connection component 50. In the embodiment of the present invention, such a base plate 11 is used to accommodate the high-voltage connection component 50, making the thickness of the base plate 11 less likely to increase and facilitating the miniaturization of the battery pack 100.

In addition, both the holding portion 113 and the coolant channel 115 are provided in the base plate 11, making full use of the space of the base plate 11 and making the battery pack 100 more compact.

Further, by providing both the holding portion 113 and the coolant channel 115 in the base plate 11, the battery component 20 and the high-voltage connection component 50 can be easily cooled by the coolant at the same time. The holding portion 113 and the coolant channel 115 can be located in the thickness direction perpendicular to the base plate 11.

As other embodiments, the coolant channels may be located at other locations, such as above or outside of the base plate 11.

Optionally, as shown in FIG. 11, FIG. 13, and FIG. 14, as an embodiment, in the base plate 11, the coolant channel 115 is configured in the horizontal direction opposite to the battery module 20, and the holding portion 113 is configured at a position staggered from the battery module 20. In other words, the coolant passage 115 is configured at a position overlapping with the battery module 20 and the holding portion 113 is configured at a position staggered from the battery module 20 when viewed in the up and down directions.

With the above structure, on the one hand, the holding portion 113 is configured at a position staggered from the battery module 20 to avoid affecting the cooling effect on the battery module 20. On the other hand, the holding portion 113 is positioned as far as possible from the battery modules 20L and 20R, so that the electromagnetic waves from the high-voltage harness 51 in the high-voltage connection component 50 can be suppressed.

As other embodiments, the holding portion 113 may also partially or fully face the battery module 20. The coolant channel and the holding portion may be configured to overlap in the up and down directions. Alternatively, the holding portion 113 is configured to be partially or fully overlapped with the battery module 20 when viewed in the up and down directions.

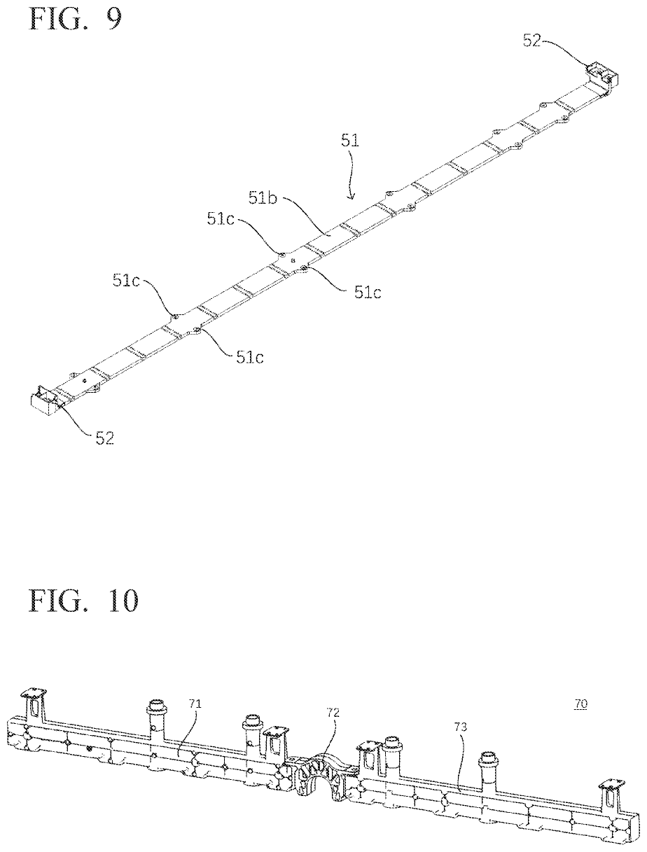

Optionally, as shown in FIG. 2, FIG. 3, FIG. 9, FIG. 12 and FIG. 15a, as an embodiment, the high-voltage connection component 50 comprises a flat high-voltage harness 51, which is accommodated in the holding portion 113 such that its thickness direction is roughly consistent with the thickness direction of the base plate, i.e., the high-voltage harness 51 can be mostly or completely accommodated in the holding portion 113. Terms that express approximations such as “roughly consistent” or “roughly equal” in the text are not limited to complete consistency or equality, but can allow certain differences, such as within 10%.

In this way, while ensuring that the high-voltage harness 51 can effectively transmit electrical energy, the height of the high-voltage harness 51 can be reduced as much as possible, thereby effectively suppressing the impact on the high-voltage harness 51 from the battery module 20 and improving the safety of the battery pack 100.

As other embodiments, other shapes of the high voltage harness may be used, such as a cylindrical shape.

Optionally, the high-voltage connection component 50 extends from one end (for example, a front end) of the base plate 11 to the other end (for example, a rear end). In this way, the strength of the base plate 11 can be improved in the direction from the one end to the other (for example, front-to-back direction), solving the problem of reduced strength of the base plate due to the setting of the holding portion.

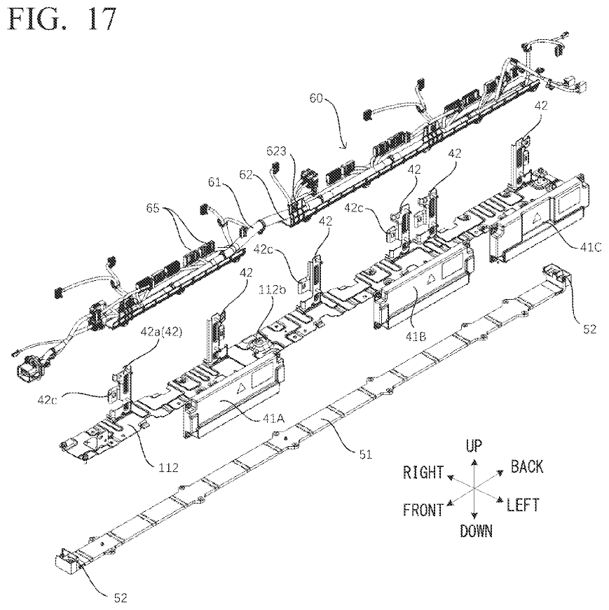

Optionally, as shown in FIG. 12, FIG. 15a, FIG. 15b, and FIG. 17, as an embodiment, the high-voltage connection component 50 comprises a high-voltage harness 51 and a high-voltage harness bracket 112. The base plate 11 (specifically the plate 116) is provided with an opening 116a, the high-voltage harness bracket 112 covers the opening 116a to form the top of the holding portion 113, and the high-voltage harness 51 is set under the high-voltage harness bracket 112.

With such a structure, the high-voltage harness 51 can be first mounted on the high-voltage harness bracket 112 during assembly, and then the high-voltage harness bracket 112 with the high-voltage harness 51 is mounted on the base plate 11. In this way, it is possible to easily install and position the high-voltage harness 51.

As other embodiments, the upper side of the holding portion 113 may be left open and closed by the plate 116. In this case, it is possible to make the holding portion run horizontally through the base plate 11, and the high-voltage connection component 50 can be inserted horizontally into the holding portion during assembly.

Optionally, as shown in FIG. 12, FIG. 15a, etc., as an embodiment, the lowest point of the high-voltage harness bracket 112 is located on a horizontal plane that is roughly the same as or lower than the upper surface of the base plate 11. It can be understood that the lowest point of the high-voltage harness bracket 112 is located on a horizontal plane that is roughly the same as or lower than plate 116.

By adopting the above structure, combined with the flat structure of the high-voltage harness 51, it is easy to make the height of the high-voltage harness bracket 112 roughly the same as or lower than the plate 116. In this way, the battery module 20 can be reliably prevented from hitting or squeezing into the high-voltage connection component 50 and the high-voltage harness 51 when moving horizontally.

As other embodiments, the height of the high-voltage harness bracket 112 can also be higher than the plate 116. When the battery module 20 is impacted, the movement may be rotation, for example, when the outer end moves upward in the left and right directions, the high voltage connection component 50 is arranged in the holding portion 113 of the base plate 11, which reduces the height, so that the risk of the high voltage connection component 50 being impacted or squeezed by the battery module 20 can also be suppressed.

Optionally, as shown in FIGS. 2, 3, 9, 12 and 15a, as an embodiment, the high-voltage harness 51 comprises a cladding layer 51b and a conductive component 51a arranged within the cladding layer 51b, which is fixed on the high-voltage harness bracket 112.

By adopting the above structure, the cladding layer 51b can ensure the insulation of the conductive component 51a while also fixing the conductive component 51a on the high-voltage harness bracket 112.

Optionally, as shown in FIGS. 3, 12, 15a, 16, etc., as an embodiment, the battery pack 100 also comprises a low-voltage connection component 60 electrically connected with the battery module 20, and the low-voltage connection component 60 is arranged above the high-voltage harness bracket 112.

In this way, the low-voltage connection component 60 can be configured close to the high-voltage connection component 50, making the structure compact and effectively utilizing space to improve the space utilization efficiency within the battery pack 100.

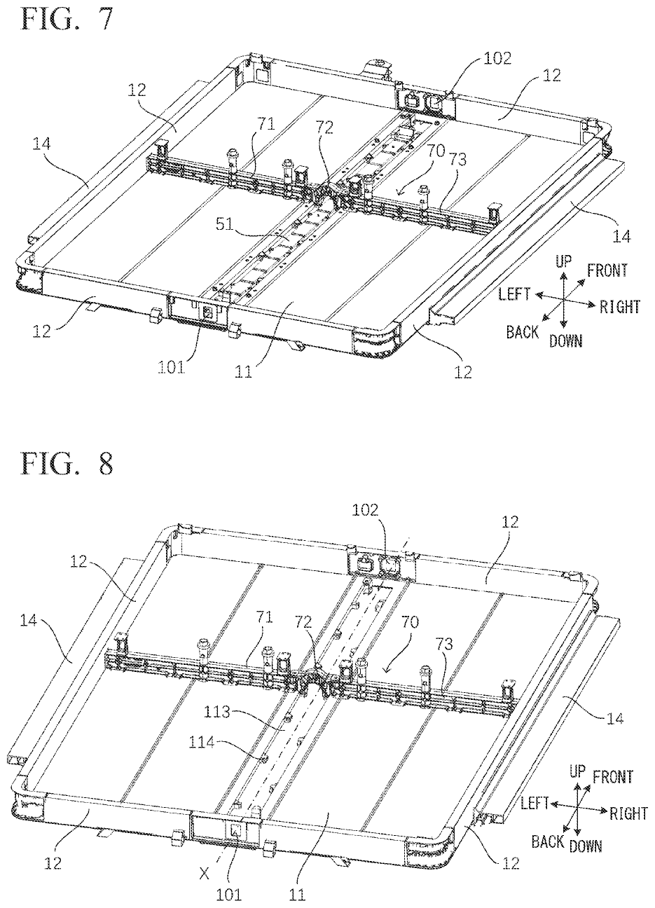

Optionally, as shown in FIG. 7, etc., as an embodiment, a reinforcing component 70 is provided above the base plate 11. The reinforcing component 70 may extend in the extension direction of the base plate 11. In this way, it can enhance the lateral strength of the base plate 11 without occupying the space inside the base plate 11, thereby making better use of the space inside the base plate 11 to set up coolant channels 115. Optionally, the holding portion 113 can be in the shape of a long groove or a long hole, and the reinforcing component 70 intersects it and extends with the holding portion 113 (i.e., intersects in the extension direction of the holding portion 113).

Optionally, referring to FIG. 11, as an embodiment, the portion of the coolant channel 115 that is farther from the centerline X (FIG. 8) of the base plate 11, i.e., the coolant channel 115a, is located upstream along the liquid flow and closer to the centerline X of the base plate 11, and a portion of the coolant channel 115 that is closer to the centerline X of the base plate 11, i.e., the coolant channel 115b, is located downstream along the fluid flow. The centerline X extends in the extension direction of the base plate 11 (e.g., front and back directions).

With the above structure, the part of the battery module 20 located away from the centerline X is more susceptible to external influences. Therefore, in this embodiment, cooling the part of the battery module 20 away from the center line X first can provide good cooling to the battery module 20 and improve the cooling efficiency.

The cooling of the part of the battery module 20 located away from the center line X is more susceptible to external influences.

It will be appreciated that the coolant channels may be one or more.

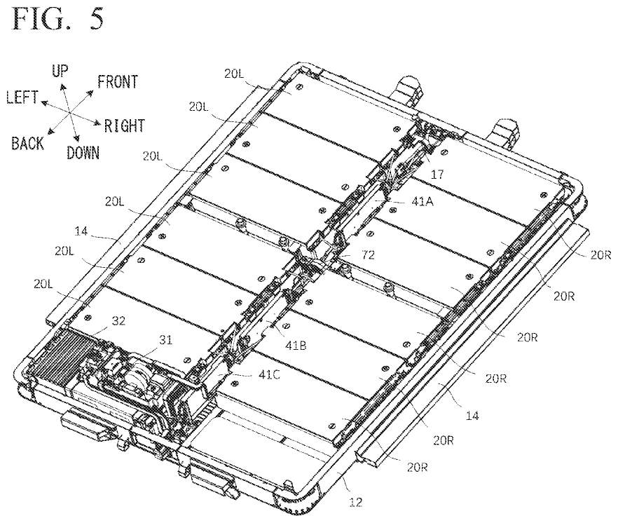

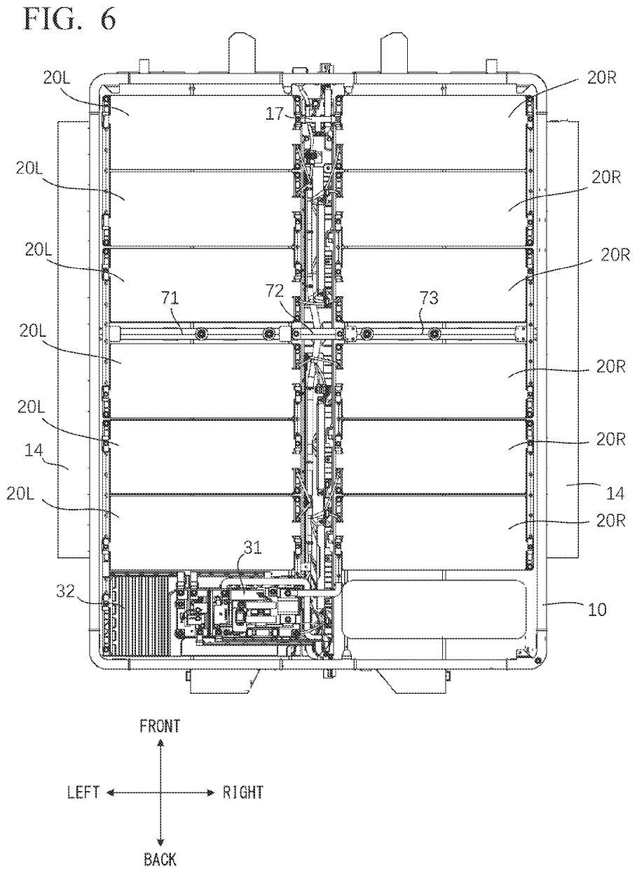

Optionally, as shown in FIG. 2, FIG. 3, FIG. 5, and FIG. 6, as an embodiment, the battery module 20 comprises a plurality of battery modules 20L (the first battery modules) and a plurality of battery modules 20R (the second battery modules). The battery modules 20L and the battery modules 20R are supported on the upper surface of the base plate 11. The plurality of battery modules 20L are arranged in the front and back directions (an example of the first direction) along the upper surface of the base plate 11, and the plurality of battery modules 20R are arranged in the front-to-back direction along the upper surface of the base plate 11. The plurality of battery modules 20L and the plurality of battery modules 20R are arranged with a gap S in the left and right directions (an example of the second direction) that intersect with the front and back directions. The holding portion 113 is configured at a position opposite to the gap S, i.e., at a position overlapping the gap S in the up and down directions.

In this way, the holding portion 113 is arranged at a roughly central position in the left and right directions of the base plate 11, which can reduce the impact force on the high-voltage harness 51 during lateral collisions and suppress damage to the high-voltage harness 51, when compared to when the holding portion 113 is arranged at a position at the outer part of the base plate 11.

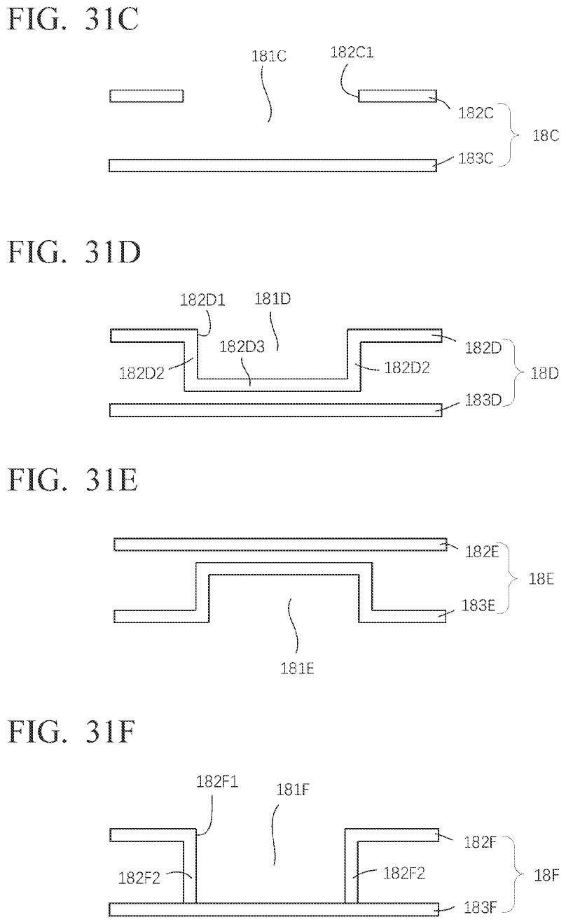

Optionally, as an embodiment, as described in FIG. 31a, the holding portion 181A comprises a cavity provided within the base plate 18A, or, as another embodiment, as shown in FIGS. 31b to 31f, the holding portion comprises an opening formed in the upper or lower surface of the base plate, for example, openings 182C1, 182D1, 182F1, etc., shown in the accompanying drawings.

The above structure allows easy removal or maintenance of the electrical connection component through openings on the upper or lower surface of the base plate.

Optionally, in some embodiments, as shown in FIGS. 31c to 31f, the base plate comprises a first plate (for example, a plate 182C, a plate 182D, a plate 182E and a plate 182F) and a second plate (for example, a plate 183C, a plate 183D, a plate 183E and a plate 183F). The first plate is disposed above the second plate, and configured opposite and spaced apart from the second plate. The opening is provided in the first plate or the second plate. Specifically, the opening may be provided on the first plate or the second plate, or on the upper surface of the first plate or on the lower surface of the second plate.

With the above structure, the first plate is spaced apart from the second plate, and the spacing between the two is used to form the holding portion, resulting in a simple structure.

Optionally, in some embodiments, as shown in FIG. 31d and FIG. 31f, the holding portion also comprises a partitioning wall (for example, a partitioning wall 182D2 and a partitioning wall 182F2) that extends from one edge of the opening and extends from one of the first and second plates to the other.

With the above structure, when the base plate is subjected to an external force in the up and down directions, the partitioning wall can contact the other of the first plate and the second plate, thereby improving the strength of the base plate.

Optionally, as an embodiment, as shown in FIG. 31d, there are two partitioning walls, i.e., the left-hand partitioning wall 182D2 and the right-hand partitioning wall 182D2 of the figure (corresponding to the first and second partitioning walls in the present invention), and two partitioning walls 182D2 are provided on the edge of each side of the opening 182D1. The holding portion 181D also has a bottom wall 182D3, which is connected to the two partitioning walls 182D2.

With the above structure, the holding portion is seen as a recess from the side with the opening and as a projection from the side without the opening. The first or second plate is formed with a reinforcing rib (similar to a pressed rib) structure, thereby increasing the strength of the first or second plate and the base plate.

Optionally, as an embodiment, the bottom wall contacts the other of the first plate and the second plate or is spaced apart from the other of first plate and the second plate.

With the bottom wall set to contact the other of the first plate and the second plate, the strength of the base plate can be reliably increased.

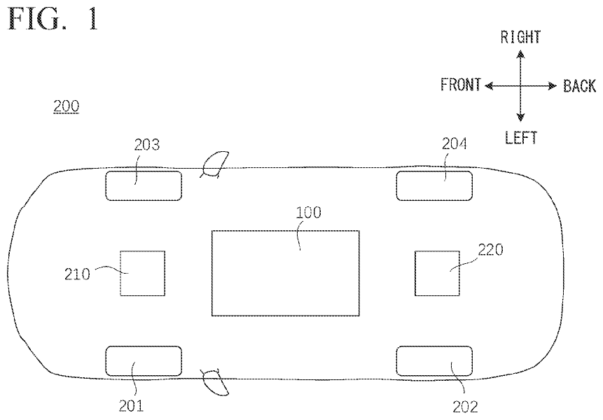

As shown in FIG. 1, embodiments of the present invention also provide a vehicle 200 that comprises a battery pack 100 of either of the above structures.

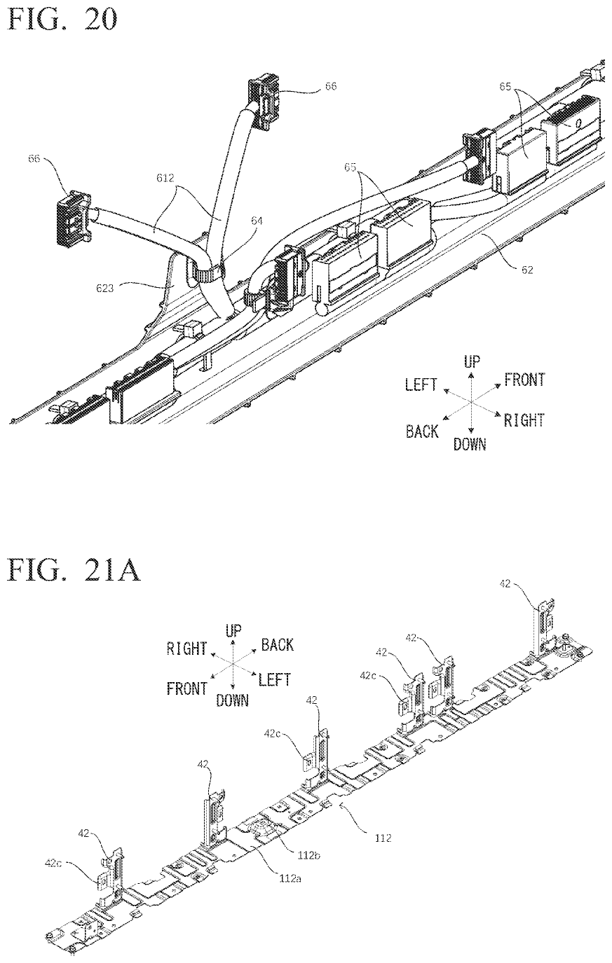

FIGS. 1 to 29 illustrate an embodiment of the present invention, which is described in detail below.

### Vehicle

FIG. 1 is a schematic diagram of a vehicle involved in an embodiment of the present invention. As shown in FIG. 1, the vehicle 200 is an electric vehicle comprising a battery pack 100, electric motors 210 and 220, and wheels 201 to 204. The battery pack 100 supplies power to the motors 210 and 220. The motor 210 is configured at the front of the vehicle 200, in front of the battery pack 100, and is used to drive the two front wheels 201 and 203. The motor 220 is located at the rear of the vehicle 200, behind the battery pack 100, and is used to drive the two rear wheels 202 and 204. When the driver is driving manually or when the vehicle 200 is driving automatically, the battery pack 100 supplies power to the motor 210 and/or the motor 220, and the motor 210 and/or the motor 220 drives the wheels 201 and 203 and/or wheels 202 and 204 to move the vehicle 200 forward or backward.

There is no particular limitation on the type of vehicle 200, which may be, for example, a car, a truck, a passenger bus, or a sport utility vehicle (SUV).

Further, the vehicle 200 shown in FIG. 1 is a purely electric vehicle. However, the present invention is not limited to this, but can also be applied to a hybrid vehicle.

Further, the vehicle 200 illustrated in FIG. 1 comprises front and rear motors 210 and 220. However, the number and configuration of motors in the present invention are not limited to this, but the vehicle 200 may also include, for example, four hub motors or wheel side motors, or include three motors, etc. When three motors are included, it is possible, for example, to have one motor at the front of the vehicle 200 and two motors at the rear of the vehicle 200.

### Overall Battery Pack

FIG. 2 is a schematic diagram of the principle of a battery pack involved in this embodiment of the present invention. As shown in FIG. 2, the battery pack 100 comprises a housing 10, battery modules 20L and 20R, high voltage connection components 50 and 55, and a power distribution device 31. The battery modules 20L are located in the left side of housing 10 and the battery modules 20R are located in the right side of housing 10. The battery modules 20L and 20R are spaced apart in the left and right directions, and a gap S is provided between the two such that the housing 10 has an intermediate area between the left side area of the battery module 20R and the right side area of the battery module 20R. In this document, the attached drawings are marked with the symbols “S” and S. In this document, the letters L and R in the attached markings “20L and 20R” denote left and right, respectively, and are abbreviated as battery module 20 when the right and left are not distinguished.

The power distribution device 31 is responsible for transferring or transmitting electrical energy from the battery pack 100 to the motors 210 and 220 or the air conditioning compressor (not shown) and other high voltage systems, etc.

In addition, as shown in FIG. 2, connectors 52 and 53 are provided at the front and rear portions of the housing 10, respectively. All of the battery modules 20 are connected in series and then electrically connected to the power distribution unit 31. The power distribution unit 31 is electrically connected to the connector 52 at the front through the high voltage connection component 50. In addition, the power distribution unit 31 is electrically connected, through the high voltage connection component 55, to the connector 53 at the rear, which is used to electrically connect to motor 220 at the rear.

Here, the electrical connection between the connectors 52 and 53 and the motors 210 and 220 may be either a direct electrical connection or an indirect electrical connection. For example, the electrical connection can be made via an on-board AC/DC power charger, an on-board DC/DC power converter, a vehicle high voltage connection hub, etc. In addition, the voltage of the high-voltage connection components 50 and 55 is, for example, 400 V, 500 V, etc.

Further, as shown in FIG. 2, in this embodiment, the high-voltage connection component 50 extends forward from the vicinity of the power distribution device 31 to the vicinity of the connector 52 via the above intermediate area of the housing 10. This will be described in more detail later.

FIG. 3 is another schematic diagram of the structure of the battery pack 100, representing a localized structure near the central part in the left and right directions. As shown in FIG. 3, the battery pack 100 also comprises a plurality of control devices 41 of the battery management system (BMS) and a low-voltage connection component 60. The plurality of control devices 41 are used to intelligently manage and maintain all the battery modules 20L and 20R, preventing overcharging and overdischarging, prolonging service life, monitoring battery status, etc. The low-voltage connection component is used to electrically connect the control devices 41 and the battery modules 20L and 20R. The voltage of the low-voltage harness 61 is, for example, 12 V.

In addition, both the high-voltage connection component 50 and the low-voltage connection component 60 are electrical connection components in this application.

The structure of each component of the battery pack 100 is described in detail below.

### Housing

FIG. 4 is a schematic diagram of the three-dimensional structure of the battery pack 100. FIG. 5 is a schematic diagram of the three-dimensional structure of the battery pack in FIG. 4 with the top cover removed. FIG. 6 is a schematic diagram of the top view of the battery pack in FIG. 4 with the top cover removed. FIG. 7 is a schematic diagram of part of the structure of the housing of the battery pack in FIG. 4. FIG. 8 is a schematic diagram of the structure in FIG. 7 with the high-voltage harness removed.

As shown in FIG. 4, FIG. 7, and FIG. 8, the housing 10 of the battery pack 100 has an overall flat rectangular shape and comprises a base plate 11, side plates 12, an upper cover 13, and lugs 14. The base plate 11 is substantially rectangular in shape, and its length direction is consistent with the front and back directions. Also, in this embodiment, the base plate 11 has a centerline X extending in the front and back directions and is substantially symmetrical with respect to this centerline X. In this embodiment, the centerline X is also the centerline of the housing 10, which means that the housing 10 is also substantially left-right symmetrical in shape. The upper cover 13 is roughly in the same rectangular shape as the base plate 11, and is arranged relative to the base plate 11. The side plates 12 extend upwards from the edges of the base plate 11 to the upper cover 13. The base plate 11, the upper cover 13 and the side plates 12 form a space that can accommodate multiple battery modules 20. In this embodiment, the side plates 12 are fixed on the base plate 11, and the upper cover 13 is detachably installed on the side plates 12. It is understood that the shape of the battery pack 100 herein is merely an illustration and does not constitute a limitation of the present invention.

As shown in FIGS. 4, 5 and 6, the lugs 14 protrude from the outer wall surface of the side plates 12. By means of the lugs 14, the housing 10 and the battery pack 100 can be mounted on the vehicle 200.

In addition, as shown in FIG. 4, a window plate 15 is mounted at the front of the upper cover 13 and at the central part in the left and right directions. A window portion (not shown) on the upper cover 13 is opened by removing the window plate 15, so that the interior of the housing 10 can be seen. Before disassembling the battery pack 100 for maintenance, etc., it is possible to open the window plate 15 and disconnect the high-voltage circuit before disassembling the entire battery pack 100, thereby ensuring safe operation, etc.

In addition, as shown in FIG. 8, a reinforcing component 70 is provided in the housing 10, as shown in FIG. 15b, etc., and a holding portion 113 and a coolant channel 115 are provided in the base plate 11. These structures will be described in detail later.

In addition, as shown in FIG. 7 and FIG. 8, the front and rear portions of the housing 10 are provided with a connection port 102 and a connection port 101, respectively. The connection port 102 is used to configure the connector 52 (FIG. 2) to be able to connect the motor 210 at the front. In this embodiment, the connection port 101 and the connection port 102 are located on the side plates 12. In other embodiments, they can also be located on the upper cover 13 or on the base plate 11. Further, in this embodiment, the connection port 101 and the connection port 102 are located in the central part of the housing 10 in the left and right directions. As other embodiments, the connection port 101 and the connection port 102 can also be provided at other positions.

### Battery Module and Related Structure

As shown in FIG. 2, FIG. 3, FIG. 5, and FIG. 6, the plurality of battery modules 20L and the plurality of battery modules 20R are arranged on the base plate 11 (specifically, plate 116) in the front and back directions, respectively. Furthermore, there is a gap S in the left and right directions between the battery modules 20L and the battery modules 20R. In addition, each of the battery modules 20L and 20R is roughly rectangular in shape, with its height direction consistent with the up and down directions, the short side direction consistent with the front and rear directions, and the long side direction consistent with the left and right directions. In other words, the plurality of battery modules 20L and the plurality of battery modules 20R are each arranged in such a way that the long sides are adjacent to each other and the short sides are aligned.

In addition, as shown in FIG. 2 and FIG. 5, the positive and negative electrodes of each battery module 20 are located at both ends in the left and right directions, respectively. Also, in the plurality of battery modules 20L on the left side and the plurality of battery modules 20R on the right side, the positive and negative electrodes of the adjacent battery modules 20 are arranged opposite to each other. That is, for example, if one left battery module 20L (or right battery module 20R) has the positive electrode on the left and the negative electrode on the right, then the other left battery module 20L (or right battery module 20R) adjacent to it has the positive electrode on the right and the negative electrode on the left. Therefore, referring to the wiring between adjacent left battery modules 20L (or right battery modules 20R) in FIG. 2, it can be seen that the length of the wiring between battery modules can be shortened.

In addition, between the pluralities of battery modules 20L and 20R, the positive and negative electrodes of adjacent or opposite battery modules 20 are oppositely configured. That is to say, for example, if the positive electrode of a left battery module 20L is at the left end and the negative electrode is at the right end, then the adjacent or opposite right battery module 20R also has a positive electrode at the left end and a negative electrode at the right end. Therefore, referring to the wiring between the two battery modules 20L and 20R at the forefront in FIG. 2, it can be seen that the length of the wiring between the battery modules can be shortened.

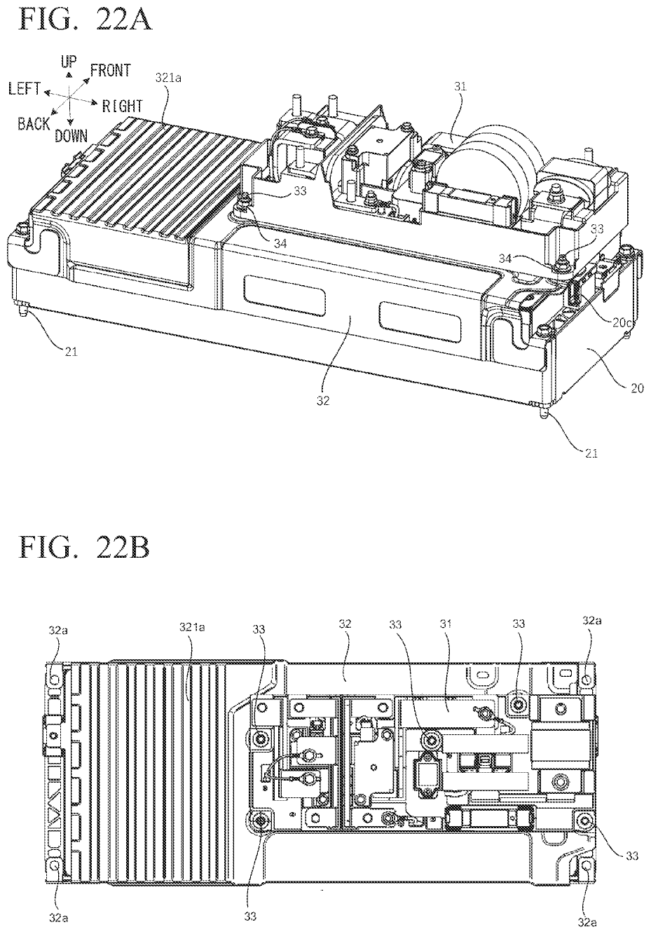

FIG. 25 is a schematic diagram of a three-dimensional structure of the battery module involved in this embodiment. In addition, FIG. 25 illustrates a battery module 20L on the left side, but the battery module 20R on the right side has the same structure except that it is configured in a different direction. As shown in FIG. 25, the battery module 20 is roughly rectangular in shape, with the long side in the left and right directions, the short side in the front and back directions, and the height direction in line with the up and down directions. The battery module 20 has a main part 20a, and a plurality of mounting holes 20b are provided in the main part 20a. A plurality of bolts 21 (FIGS. 22a and 15a) are inserted through each of the mounting holes 20b to fix the battery modules 20 to the base plate 11 of the housing 10.

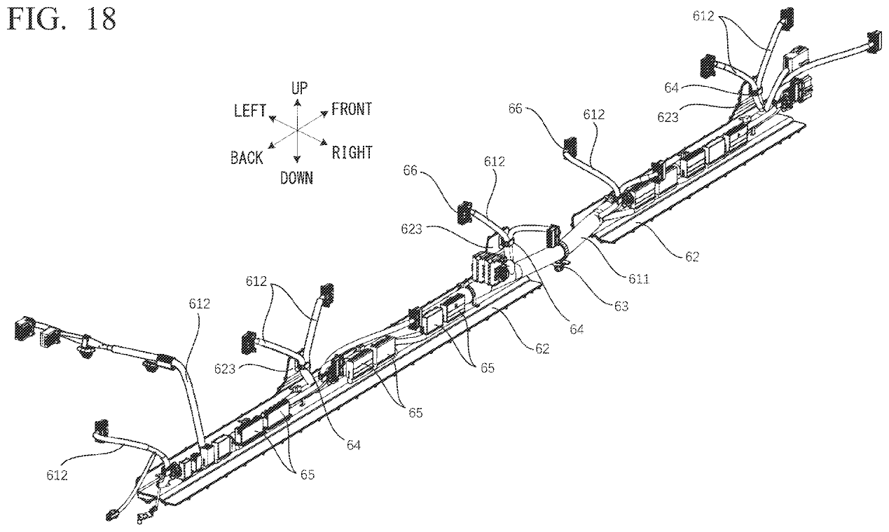

In addition, as shown in FIG. 25 and FIG. 15a, a wiring port 20c is provided at one of the left and right ends of the main part 20a. The wiring port 20c is used to electrically connect the connector 66 of the low-voltage connection component 60 (FIG. 18 to FIG. 20), which in turn electrically connects to the control device 41 (FIG. 15, etc.). In this embodiment, as shown in FIG. 25, in the case where the battery module is the battery module 20L on the left side, the wiring port 20c is located at the right end of the battery module 20L, and in the case where the battery module is the battery module 20R on the right side, the wiring port 20c is located at the left end of the battery module 20R. In other words, the wiring port 20c is configured at the end of the gap S between the battery module 20L on the left and the battery module 20R on the right, near the middle of the battery module 20. In this way, since the control device 41 is configured in the gap S, it is possible to configure the wiring port 20c close to the control device 41 and shorten the wiring length between the control device 41 and the battery module 20.

As shown in FIGS. 5 and 6, a jumper bracket 17 is provided between the two front-most battery modules 20L and 20R, which is bridge-shaped and convexly arched upward, with one end attached to the battery module 20L on the left and the other end connected to the battery module 20R on the right. The jumper bracket 17 is obstructed near the top of a terminal block 58 that will be described below, and the window plate 15 described above covers the jumper bracket 17. The jumper bracket 17 is equivalent to a switch (manual service switch) for the high-voltage system circuit inside the battery pack 100, and before disassembling the battery pack 100 for maintenance, etc., the window plate 15 can be opened and then the jumper bracket 17 can be removed so that the high-voltage circuit cannot generate conduction and is disconnected, thereby allowing safe maintenance work to be performed on the high-voltage system.

The battery pack 20 may contain a plurality of cells (single cells) that may be accommodated within a rectangular battery module housing and arranged along the long side of the battery module housing. It goes without saying that the number of cells does not constitute a limitation of the present invention, and even if the battery module 20 only has one cell, it does not affect the implementation of the present invention.

### High-Voltage Connection Components and Related Structures

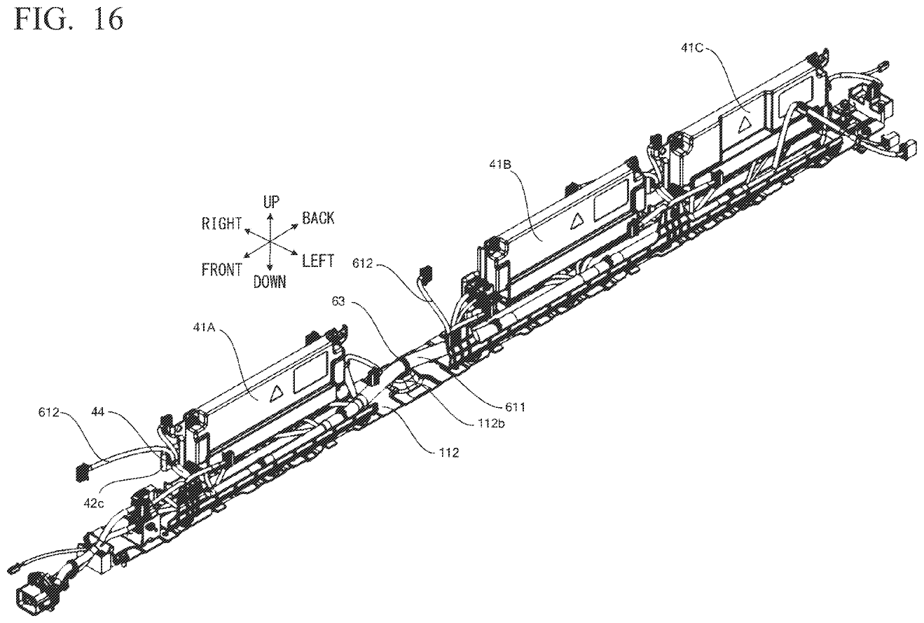

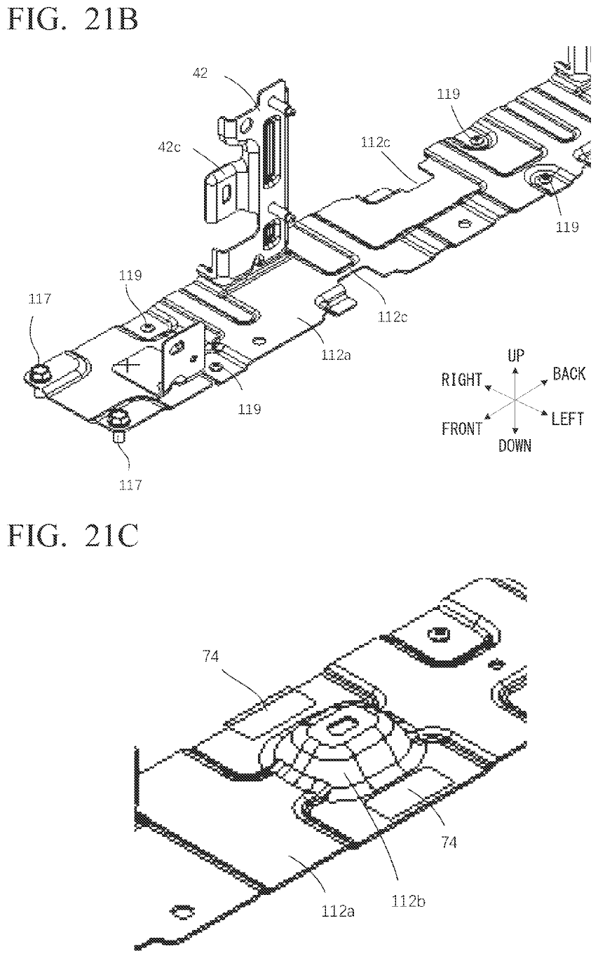

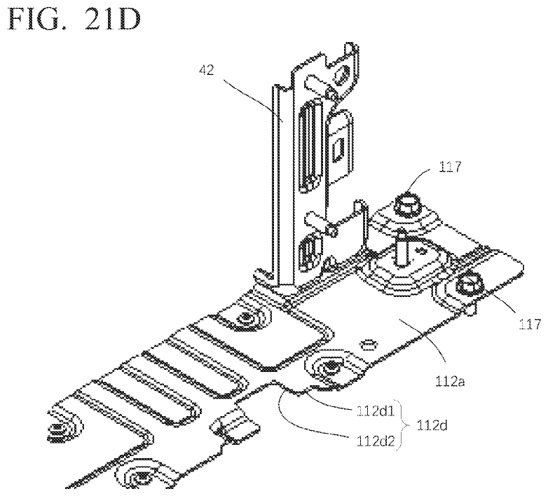

FIG. 9 is a schematic diagram of the structure of the high-voltage harness involved in this embodiment; FIG. 11 is a cross-sectional schematic diagram of the structure in FIG. 6; FIG. 12 is a partially enlarged view of the structure in FIG. 11; FIG. 13 is another cross-sectional schematic diagram of the structure in FIG. 6; FIG. 14 is a partially enlarged view of the structure in FIG. 13; FIG. 15a is another partially enlarged view of the structure in FIG. 13; FIG. 16 is a schematic diagram of the combined state of the low-voltage connection component and the control device and its peripheral structures involved in this embodiment; FIG. 17 is a schematic diagram of the structure in FIG. 16 in a disassembled state; FIG. 21a is a schematic diagram of the structure of the combined state of the high-voltage harness bracket and the control device bracket involved in this embodiment; FIG. 21b is a partially enlarged view of the structure illustrated in FIG. 21a; FIG. 21c is another partially enlarged view of the structure illustrated in FIG. 21a; and FIG. 21d is another partial enlargement of the structure illustrated in FIG. 21a.

As shown in FIG. 3, FIG. 12, FIG. 15a, FIG. 16 and FIG. 17, the high-voltage connection component 50 comprises a high-voltage harness 51, a terminal block 58 (an example of a connector) and a high-voltage harness bracket 112. The high-voltage harness 51 is a long component used for transmitting electrical energy. There are two terminal blocks 58 located at both ends of the high-voltage harness 51, one for electrical connection to the power distribution device 31 and the other for electrical connection to connector 52 (FIG. 2). The high-voltage harness 51 is installed on the high-voltage harness bracket 112, which is installed on the base plate 11, that is, the high-voltage harness 51 is installed on the base plate 11 through the high-voltage harness bracket 112.

It can be understood that a “wire harness” can be made of multiple wires or a single wire.

As shown in FIGS. 2, 3, 9, 12 and 15a, the high-voltage harness 51 is flat in a cross section. Specifically, in this embodiment, its cross section is roughly flat and rectangular. Here, the cross section is the section perpendicular to the wire length direction of the high-voltage harness 51. “Flat” refers to a shape where the dimensions in one dimension are smaller than those in another dimension. For example, in the state shown in FIG. 12, the height dimension (in the up and down directions) of the high-voltage harness 51 is smaller than the width dimension (in the left and right directions). Therefore, the height direction of the high-voltage harness 51 is also the thickness direction. It can be understood that, under the same conductivity, flat cables can reduce the size in one direction compared to circular or square cables. For example, referring to the circular low-voltage harness 61 and the flat high-voltage harness 51 shown in FIG. 12, it can be seen that the dimensions of the high-voltage harness 51 in the up and down directions are significantly smaller than those of the low-voltage harness 61. Additionally, it may be worth noting that the low-voltage harness 61 and the high-voltage harness are separated here. The comparison is made to illustrate the characteristics of the flat high-voltage harness 51, and there is no need for the conductivity of the low-voltage harness 61 and the high-voltage harness 51 to be the same.

Referring to FIGS. 3 and 12, the high-voltage harness 51 comprises a conductive component 51a and a cladding layer 51b cladding the conductive component 51a. The conductive component 51a is made of a metal, and as an example of its material, copper can be used, that is, the conductive component 51a is a copper bar. It goes without saying that the conductive component 51a can also be made of other conductive materials. As the cladding layer 51b is an insulation layer, as an example of its material, a plastic can be used. It goes without saying that the cladding layer 51b can also be made of other materials, such as rubber.

In addition, in this embodiment, there are two conductive components 51a, each covered by a cladding layer 51b, thereby reliably avoiding short circuits between the two conductive components 51a. Moreover, in this embodiment, the cross section of the conductive components 51a is roughly rectangular, and the cross section of the cladding layers 51b is also roughly flat and rectangular. The long side directions of the rectangles of the conductive components and their cladding layers are parallel, and the short side directions are parallel.

As shown in FIG. 3, FIG. 12, and FIG. 15a, the base plate 11 is provided with a holding portion 113, and the high-voltage connection component 50 is configured in the holding portion 113.

As shown in FIGS. 3, 12, 15a and 15b, the base plate 11 of the housing 10 comprises a plate 111 and a plate 116, which are opposite and spaced from top to bottom. The plate 116 is located above the plate 111, and the battery module 20 is configured above the plate 116. The holding portion 113 is arranged in the height range between the plate 111 and the plate 116 in the up and down directions.

In this way, for example, when the vehicle is impacted laterally, the battery pack 100 will deform, and the battery module 20 will move in horizontal and other directions. However, since the high-voltage connection component 50 is arranged in the base plate 11 below the battery module 20, the battery module 20 is unlikely to hit the high-voltage connection component 50, thus preventing the high-voltage connection component 50 from deformation, damage, fracture, leakage and electrical connection damage (including poor contact or electrical connection failure), improving the safety and reliability of battery pack 100.

In this embodiment, the base plate 11, as well as the plates 111 and 116, is horizontally configured, with an extension direction roughly consistent with the horizontal direction and a thickness direction roughly consistent with the up and down directions.

In addition, as shown in FIGS. 11, 13 and 14, in this embodiment, a plurality of coolant channels 115 are formed between the plate 111 and the plate 116. That is to say, the holding portion 113 and the coolant channel 115 are between the plate 111 and the plate 116, so that the high-voltage connection component 50 (high-voltage harness 51) can be easily cooled by the coolant channel 115.

In addition, the coolant channels 115 are configured directly below the battery modules 20L and 20R, and when viewed in the up and down directions, the coolant channels 115 coincide with the battery modules 20L or battery modules 20R. That is to say, the coolant channels 115 are horizontally arranged towards the battery modules 20L and 20R, and are close to the battery modules 20L and 20R, so that the battery modules 20L and 20R can be effectively cooled.

As shown in FIG. 13, FIG. 15a, etc., the holding portion 113 (and the high-voltage connection component 50 therein) is configured in the horizontal direction at a position staggered from the battery modules 20L and 20R, as viewed in the up and down directions. In this way, it is possible to use the part of the base plate 11 that is not equipped with coolant channels 115 to configure the holding portion 113, effectively utilizing the space of the base plate 11, making the battery pack 100 more compact and easily miniaturized. Moreover, on the one hand, it is possible to avoid affecting the cooling effect on the battery modules 20, and on the other hand, it is possible to suppress electromagnetic waves of the high-voltage harness 51 from interfering with the battery modules 20L and 20R by arranging the holding portion 113 as far away as possible from the battery modules 20L and 20R.

Furthermore, in this embodiment, the battery modules 20L are configured at the left side of the base plate 11, the battery modules 20R are configured at the right side of the base plate 11, the holding portion 113 is provided in the middle part between the left side and the right side, and the high-voltage connection component 50 is configured in the holding portion 113. In other words, in the base plate 11, the holding portion 113 is horizontally configured between the battery modules 20L on the left side and the battery modules 20R on the right side. The holding portion 113 faces the gap S, and coincides with the gap S when viewed in the up and down directions. In this way, it is possible, for example, to reduce the impact force on the high-voltage harness 51 during a collision and suppress damage to the high-voltage harness 51, etc., compared to a position of the holding portion 113 near the outer part of the base plate 11 in the left and right directions.

In addition, as shown in FIG. 3, FIG. 12, FIG. 15a, etc., in this embodiment, the high-voltage harness 51, like the high-voltage connection component 50, is also flat in cross-section and is accommodated in the holding portion 113 such that its thickness direction is approximately the same as the thickness direction of the base plate 11, i.e., the high-voltage connection component 50 and the high-voltage harness 51 are placed horizontally in the holding portion 113. In this way, the height position of the high-voltage harness 51 can be reduced as much as possible on the basis of ensuring that the high-voltage harness 51 can effectively transmit electrical energy, so that the high-voltage harness 51 can be effectively protected from being hit by the battery module 20 and the safety of the battery pack 100 can be improved. As mentioned above, “flat” means a shape in which a dimension in one direction is smaller than a dimension in another direction, and on this basis, it is understood that the thickness direction of the flat high-voltage harness 51 is the direction in which the dimension of the two aforementioned dimensions is relatively smaller, which in this embodiment is generally consistent with the up and down directions.

As shown in FIG. 15b, the upper side of the holding portion 113 has an opening 116a,which may also be described as an opening formed in the plate 116. During assembly, the high voltage connection component 50 can be placed into the holding portion 113 through this opening 116a. In addition, a support portion 113b, which is used to carry and fix the high-voltage harness bracket 112, is provided in the holding portion 113. In this embodiment, the support portion 113b is in a stepped shape, and the high-voltage harness bracket 112 is supported by the upper surface of the support portion 113b. In addition, as shown in FIG. 15b, the housing 10 also comprises a plate 110 that covers the bottom of the plate 111, for example to protect the plate 111. In addition, in this embodiment, the holding portion 113 is formed as a long slot extending in front and back directions with an opening 116a facing upward.

Further, as shown in FIG. 12, FIG. 15a, and FIG. 17, in this embodiment, the high voltage harness 51 is mounted from below on the high voltage harness bracket 112, which covers the opening 116a and forms the top of the holding portion 113. During assembly, the high-voltage harness 51 can be mounted on the high-voltage harness bracket 112 first, and then the high-voltage harness bracket 112 with the high-voltage harness 51 is mounted on the base plate 11. In this way, the high voltage harness 51 can be easily installed and positioned.

Further, in this embodiment, the bottom of the holding portion 113 is formed by the plate 111.

Further, in this embodiment, the holding portion 113 extends from the front end portion of the base plate 11 to the rear end portion, and the high-voltage harness bracket 112 is in a long shape and extends from the front end portion of the base plate 11 (or the plate 116) to the rear end portion, covering substantially the entire holding portion in the front and back directions. Thus, the strength of the base plate 11 in the front and back directions can be increased by the high-voltage harness bracket 112. Further, the high-voltage harness bracket 112 is in a long shape and the high-voltage harness 51 is in a long shape, and both are configured to be in the same length direction, such that the high-voltage connection component 50 is also in a long shape and extends from the front end portion of the base plate 11 (or the plate 116) to the rear end portion.

Further, in this embodiment, the high-voltage harness 51 is fixed to the high-voltage harness bracket 112 by fixing the cladding layer 51b to the high-voltage wire harness bracket 112. In this way, the cladding layer 51b both insulates the conductive component 51a and fixes the conductive component 51a to the high-voltage harness bracket 112.

As a more specific structure, as shown in FIG. 9, a protrusion 51c is provided on each side surface of the cladding layer 51b of the high-voltage harness 51 in the width direction, through which the high-voltage harness 51 is fixed to the high-voltage harness bracket 112. Specifically, for example, a through-hole may be provided in the protrusion 51c so that a rivet or screw 119 (FIG. 21b) can pass through the through-hole and fixes the high-voltage harness 51 to the high-voltage harness bracket 112. In addition, the present invention is not limited to this, for example, a snap can be provided on the high-voltage harness bracket 112 so that the protrusion 51c snaps into the snap, thereby fixing the high-voltage harness 51 to the high-voltage harness bracket 112. In addition, in this embodiment, a plurality of protrusions 51c are provided on each side in the width direction of the cladding layer 51b, and the plurality of protrusions 51c are arranged in the length direction of the high-voltage harness 51. In this way, the plurality of positions in the length direction of the high-voltage harness 51 are fixed to the high-voltage harness bracket 112, thereby enabling the bonding strength of the high-voltage harness 51 and the high-voltage harness bracket 112 to be improved and the strength of the high-voltage connection component 50 to be improved, so that an impact force from the front and back directions can be effectively resisted.

Further, in this embodiment, the protrusion 51c is integrally formed with the cladding layer 51b.

Alternatively, the holding portion 113 may pass through the plate 116 in the front and back directions, may not pass through the plate 116, or may pass through one end without passing through the other end.

As shown in FIG. 12, FIG. 15a, etc., in this embodiment, the height of the high-voltage harness bracket 112 is lower than the plate 116, i.e., the high-voltage harness bracket 112 is lower than the plate 116 in the up and down directions. Alternatively, as other embodiments, the high-voltage harness bracket 112 may be at approximately the same height as the plate 116, or may also be higher than the plate 116.

In this embodiment, the high-voltage harness bracket 112 is a metal part so that the electromagnetic waves of the high-voltage harness 51 can be shielded and the electromagnetic waves of the high-voltage harness 51 can be suppressed from interfering with the battery module 20, etc. The high-voltage harness bracket 112 is, for example, a sheet metal part. In other embodiments, the high-voltage harness bracket 112 may be made of other materials, such as a plastic.

By arranging the high-voltage harness bracket 112 lower than or at approximately the same height as the plate 116, the horizontal movement of the battery module 20 can be reliably inhibited from hitting, or rather squeezing, the high-voltage connection component and the high-voltage harness 51 therein.

As shown in FIG. 3, FIG. 12, FIG. 15a, FIG. 16, etc., a low-voltage connection component 60 is provided in the gap S above the high-voltage harness bracket 112 for electrically connecting the control device 41 to the battery module 20. In this way, the low-voltage connection component 60 can be configured close to the high-voltage connection component 50, resulting in a compact structure, efficient use of space, and increased efficiency of space utilization within the battery pack 100.

In addition, in this embodiment, a reinforcing component 70 is provided transversely above the plate 116, so that the overall strength of the housing 10 can be strengthened, and in addition, the reinforcing component 70 will not affect the setting of coolant channels 115 (avoiding protruding parts need not be considered in the setting of coolant channels 115).

In this embodiment, as shown in FIG. 11, there are a plurality of coolant channels 115, and the plurality of coolant channels 115 are arranged from the middle to the outer part in the left and right directions, as viewed from the front and back directions. Among them, the coolant channels 115a near the outer part are located upstream along the liquid flow, and the coolant channels 115b near the middle are located downstream along the liquid flow. In other words, the part of the coolant channel 115 that is farther from the center line X of the base plate 11, i.e., the coolant channel 115a, is located upstream along the liquid flow, and the part that is closer to the center line of the base plate 11, i.e., the coolant channel 115b, is located downstream along the liquid flow, and the coolant flows in from the coolant channel 115a and flows out from the coolant channel 115b. Thus, the coolant cools the outer part of the battery module 20 first, and in this way, the battery module 20 can be cooled effectively. Specifically, the outer part of the battery module 20 is more susceptible to external influences, and thus cooling the outer part first in this embodiment provides effective cooling of the battery module 20.

Alternatively, in this embodiment, a coolant channel 115 is provided near the periphery of the housing portion 113, thereby enabling efficient cooling of the high voltage connection component 50 (high-voltage harness 51).

Alternatively, the high-voltage connection component 50 may be completely housed in the holding portion 113 or partially housed in the holding portion 113. In this embodiment, the high-voltage harness 51 is housed in the housing portion 113 as a whole, and the terminal blocks 58 at both ends partially protrude above the high-voltage harness bracket 112, thereby enabling easy wiring operations.

As shown in FIG. 15b, in order to keep stable spacing between the plate 111 and the plate 116, one or both of the plate 111 and the plate 116 are provided thereon with a protrusion 11a that protrudes toward the other, and the protrusion 11a may be provided in a plurality. In this embodiment, the plate 111 and the plate 116 are formed separately and assembled together by bolting or welding, etc. In other embodiments, the plate 111 and the plate 116 may also be formed as one piece. In this embodiment, the protrusion 11a is formed as an elongated convex rib extending in the front and back directions.

As shown in FIG. 12, FIG. 15a, FIG. 16, FIG. 17 and FIG. 21a, the high-voltage harness bracket 112 comprises a main part 112a and a raised part 112b, wherein the main part 112a has a roughly rectangular plate shape and is roughly horizontally arranged so as to cover the opening 116a of the holding portion 113 well. The raised part 112b is raised upward from the main part 112a. It is used to fix the main wire portion 611 of the low-voltage harness 61 (FIG. 16). This will be described in more detail later.

As shown in FIGS. 8 and 29, snap portions 114 are provided on the left and right side wall surfaces 113a (FIG. 15b) of the holding portion 113, and protrude from the left and right side wall surfaces 113a of the holding portion 113. The snap portion 114 has a recess recessed toward the root side (the opening of the recess faces the middle of the left and right directions of the holding portion 113), and the high-voltage harness bracket 112 is embedded in the recess. The high-voltage wire harness bracket 112 is embedded in the recess so that its displacements in the up and down directions and the left and right directions are limited. In addition, a plurality of snap portions 114 are provided on the left and right side walls of the holding portion 113, arranged in the front and back directions. In this way, the high-voltage harness bracket 112 can be reliably kept in a stable position.

As shown in FIG. 21b, notched portions 112c are provided on both edges of the main part 112a in the width direction, the number of notched portions 112c corresponds to the number of snap portions 114 (FIG. 8) on the base plate 11, and the notched portions 112c can accommodate the snap portions 114. In this state, the high-voltage harness bracket 112 moves in the front and back directions so that the edge of the main part 112a is inserted into the snap portions 114, thereby, the snap portions 114 limit the displacement of the high-voltage harness bracket 112 in the up and down directions.

Further, in this embodiment, in order to easily insert the edge of the main part 112a into the snap portions 114, the opening width of the snap portions 114 (i.e., the opening size in the up and down directions) is greater than the thickness of the main part 112a, for example, it can be set to 1.5 times or more than 2 times the thickness of the main part 112a.

Alternatively, as a variation, the snap portion 114 can be provided on only one of the left and right side wall surfaces.

As shown in FIG. 21d, a positioning portion 112d is provided at the edge in the width direction of the main part 112a, and the positioning portion 112d has a side 112d1 and a side 112d2, wherein the side 112d1 extends in a straight line in the length direction of the main part 112a and the side 112d2 extends in a straight line in the width direction of the main part 112a. The base plate 11 of the housing 10 is provided with a positioning portion (not shown) that mates with the positioning portion 112d, and the positioning portion on the base plate 11 matches the shape of the positioning portion 112d so that the high-voltage harness bracket 112 can be positioned in the front and back directions and the left and right directions.

As shown in FIG. 21b and FIG. 21d, a plurality of mounting holes (not shown) are provided in the main part 112a, and bolts 117 can be installed in these mounting holes to fix the high-voltage harness bracket 112 to the base plate 11. In addition, in this embodiment, the mounting holes are provided at the front and back ends of the main part 112a.

When installing the high-voltage harness bracket 112, each notched portion 112c is first aligned with a snap portion 114, and then the high-voltage harness bracket 112 is moved slightly downward so that the snap portion 114 enters the notched portion 112c. In this state, the high-voltage harness bracket 112 is moved in the front and back directions so that the positioning portion 112d on the main part 112a and the positioning portion on the base plate 11 are engaged in the front and back directions, and then the high-voltage harness bracket 112 is adjusted so that the positioning portion 112d and the positioning portion on the base plate 11 are engaged in the left and right direction, thereby positioning the high-voltage harness bracket 112 in the front and back directions and the left and right directions. At the same time, the left and right edges of the main part 112a are inserted into the snap portions 114 of the base plate 11, so that the displacement of the high-voltage harness bracket 112 in the up and down directions is limited by the snap portions 114. In this state, the bolts 117 are inserted through the mounting holes in the main part 112a to fix the high-voltage harness bracket 112 to the base plate 11.

As shown in FIG. 21c, cushioning members 74 may be placed on both the left and right sides of the raised part 112b of the main part 112a, which is clamped by the main part 112a and a reinforcing member 72 of the reinforcing component 70 that will be described later (FIG. 12), for cushioning the pressure of the reinforcing component 70, or the reinforcing member 72, on the high-voltage harness bracket 112. The material of the cushioning members 74 is not particularly limited, and they may, for example be made of a metal, rubber, plastic or felt.

In this embodiment, the high-voltage harness bracket 112 is fixed to the high-voltage harness 51, thereby enhancing the strength of the base plate 11 in the front and back directions. In addition, the flat high-voltage harness 51 is overlapped and fixed with the plate-shaped high-voltage harness bracket 112, which can further enhance the strength.

### Power Distribution Device and Related Structure

As shown in FIG. 2, FIG. 5, and FIG. 6, the power distribution device 31 is mounted inside the housing 10.

As described above, the power distribution device 31 is used to transfer or transmit electrical energy from the battery pack 100 to other high voltage systems such as the motor 210 or 220 or an air conditioning compressor (not shown), etc. In this embodiment, as shown in FIG. 2, FIG. 5, FIG. 6, etc., the power distribution device 31 is configured on the rearmost battery module 20L of the plurality of battery modules 20L. The power distribution device 31 may include a relay, a current sensor, a fuse, a pre-charge resistor, etc., wherein the relay may be considered as a high current switch that cuts off the current flowing through the busbar and electrically isolates the high voltage battery from the rest of the high voltage system. The current sensor is used to detect the current flowing through the circuit. The pre-charge resistor is used to protect the system from damage from surge power sources.

In this embodiment, compared to installing the power distribution device 31 in the middle, for example, maintenance and replacement of the power distribution device 31 can be more easily carried out.

Further, as shown in FIG. 2, a connector 53 is provided at the rear of the housing 10, and the power distribution device 31 is configured at the rear of the housing 10 and is close to the connector 53 so that the wiring length between the power distribution device 31 and the connector 53 is short and can be easily wired. Specifically, since the power distribution device 31 is located close to the connector 53, the length of the high-voltage connection component 50 for connecting the power distribution device 31 and the connector 53 is shorter, and thus the high-voltage connection component 50, even when not provided in the base plate 11, can be less susceptible to impact or crushing caused by the battery module 20. In this way, only one of the high-voltage connection component 50 and the high-voltage connection component 55 needs to be subjected to the complicated operation for installation in the base plate 11, and the other does not need to be subjected to the complicated operation for installation in the base plate 11, thereby enabling easy wiring and reducing installation time.

As shown in FIG. 4, a projection 13a is provided on the upper surface of the rear part of the upper cover 13 of the housing 10, and the inner side of the projection 13a is a concave part for accommodating the power distribution device 31. In this embodiment, the power distribution device 31 is configured near the connector 53 so that the projection 13a accommodating the power distribution device 31 is set at the rear part of the housing 10, so that there are no large protrusions on the front of the housing 10 of the battery pack 100, thereby allowing more space in the cabin corresponding to the location of the battery pack 100 to accommodate the feet of the passenger.

Alternatively, the power distribution device 31 is mounted on the battery module 20 from above. In this way, it is possible to reduce the size of the gap S, reduce the size of the battery pack 100 in the left and right directions, and increase the energy density of the battery pack 100 as compared to configuring the power distribution device 31 in the gap S.

Alternatively, the power distribution device 31 is mounted on a single battery module 20. In this way, it is possible to improve the installation ease of the power distribution device 31, to improve the stability of the power distribution device 31, and to reduce the overall space occupied by the power distribution device 31, as compared to the power distribution device 31 bridging two or more battery modules 20.

In this embodiment, the power distribution device 31 is mounted on a single battery module 20L, and that battery module 20L on which the power distribution device 31 is mounted is the rearmost of the plurality of battery modules 20L. Alternatively, as other embodiments, the power distribution device 31 is not limited to the rearmost battery module 20L, but may also be configured on the other battery modules 20 at the rear. Further, as other embodiments, the power distribution device 31 may also be mounted on the battery module 20R.

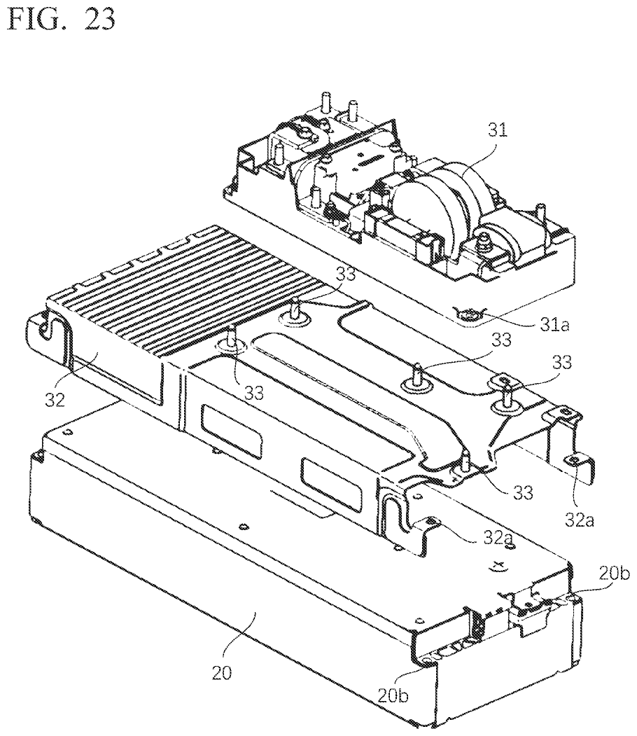

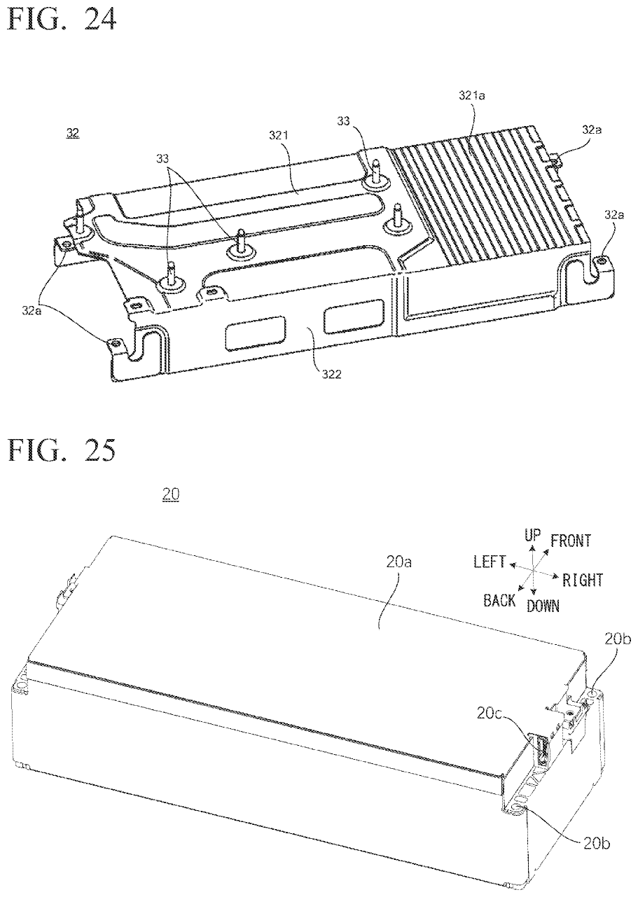

FIG. 22a is a schematic diagram of the three-dimensional structure of the combined state of the battery module, the power distribution device bracket and the power distribution device involved in this embodiment; FIG. 22b is a schematic top view of the structure in FIG. 22a; FIG. 23 is a structural schematic diagram of the structure of FIG. 22a in a disassembled state; and FIG. 24 is a schematic diagram of the three-dimensional structure of the power distribution device bracket involved in this embodiment.

As shown in FIGS. 22a and 22b, the power distribution device 31 is mounted on the battery module 20L via the power distribution device bracket 32. In this way, a special bracket is provided to mount the power distribution device 31, which can improve the stability of the power distribution device.

As shown in FIG. 22a and FIG. 24, the power distribution device bracket 32 comprises a top part 321 and side parts 322. The top part 321 is roughly in the shape of a plate to cover the upper surface of the battery module 20. There are two side parts 322 extending downward from each of the front and rear ends of the top part 321 to cover the side surfaces of the battery module 20. By forming such a shape, the top part 321 of the power distribution device bracket 32 fits the upper surface of the battery module 20 and the side parts 322 fit the side surfaces of the battery module 20, and thus, on the one hand, it is possible to improve the connection strength and to keep the power distribution device 31 in a stable position; and on the other hand, it is possible to make the power distribution device bracket 32 compact with the battery module 20, avoid increasing the size of the power distribution device bracket 32, reduce the occupied space, and facilitate the miniaturization of the battery pack 100.

As other embodiments, there may be only one side part 322.

Alternatively, a plurality of mounting holes 32a are provided in the side part 322 for mounting the power distribution device bracket 32 on the battery pack 20.

More specifically, as shown in FIG. 23 and FIG. 25, a plurality of mounting holes 20b are provided in the battery module 20, and as shown in FIG. 15a and FIG. 22a, a bolt 21 passes through the mounting holes 32a and 20b in sequence and is screwed into a nut 22 provided in the base plate 11, so that the power distribution device bracket 32 can be installed on the battery module 20 by using the structure (bolt 21, nut 22) that installs the battery module 20 on the base plate 11, without additional installation structures on the battery module 20, simplifying the structure and reducing the manufacturing cost.

In the present embodiment, the mounting holes 32a are configured above the mounting holes 20b, however, in other embodiments, the mounting holes 32a may be configured below the mounting holes 20b, i.e., the part of the power distribution device bracket 32 with the mounting holes 32a is inserted between the battery module 20 and the base plate 11. It can be seen that “a bolt 21 passes through the mounting holes 32a 20b in sequence” herein is not limited to a bolt 21 passing through the mounting hole 32a and then the mounting hole 20b, but rather a bolt 21 passing through one of the mounting hole 32a and the mounting hole 20b and then the other.

Alternatively, as shown in FIG. 22a, FIG. 22b, FIG. 23 and FIG. 24, a plurality of bolts 33 are provided on the upper surface of the top part 321 of the power distribution device bracket 32 for mounting the power distribution device 31 on the power distribution device bracket 32. Specifically, it is possible to mount the power distribution device on the power distribution device bracket 32 by making the bolts 33 pass through the mounting holes 31a in the power distribution device 31 and screw the nuts 34 on the threaded parts of the bolts.

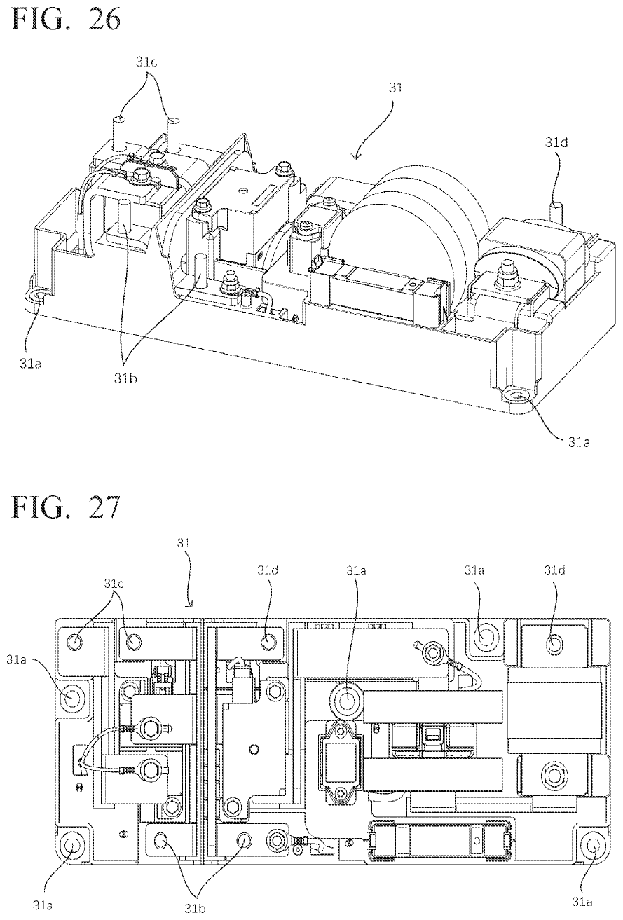

As shown in FIG. 22a and FIG. 26, wiring terminals 31b, wiring terminals 31c and wiring terminals 31d are provided on the power distribution device 31, and there are two wiring terminals 31b, two wiring terminals 31c and two wiring terminals 31d. Among them, the wiring terminals 31b are used to electrically connect the rear connector 53 through the high-voltage connection component 55 so as to be able to electrically connect the motor 220 at the rear; the wiring terminals 31c are used to electrically connect the battery modules 20 in series; and the wiring terminals 31d are used to electrically connect the front connector 52 through the high-voltage connection component 50 so as to be able to electrically connect the motor 210 at the front.

As shown in FIG. 22b, the dimensions in the front and back directions and in the left and right directions of the power distribution device bracket 32 are roughly the same as those of the battery module 20, and the dimensions in the front and back directions and in the left and right directions of the power distribution device 31 are smaller than those of the power distribution device bracket 32 and the battery module 20, so that it is possible to better set the mounting points of the power distribution device bracket 32, and thus the power distribution device bracket can be more securely fixed above the battery module.

As shown in FIGS. 22a and 22b, the power distribution device 31 is disposed in the left and right directions near the right end of the power distribution device bracket 32, that is, near the center of the housing 10 or the base plate 11 in the left and right directions. In this way, the wiring length between the power distribution device 31 and the connector 53 or the high-voltage harness 51 can be shortened, saving costs and facilitating wiring.

More specifically, one or more bolts 33 for mounting the power distribution device 31 are provided at the right end of the power distribution device bracket 32, so that the power distribution device 31 can be configured at the right end of the power distribution device bracket 32 in the left and right directions.

In addition, in this embodiment, the bolts 33 are fixed to the upper surface of the power distribution device bracket 32 by welding or integral molding, etc., and the power distribution device 31 is mounted by screwing the nuts 34 from one side of the power distribution device 31. In this way, there is no need to leave space for setting nuts 34, etc. on the lower surface side of the top part 321 of the power distribution device bracket 32, so that the top part 321 can fit the battery module 20 well, which helps to improve the stability of the power distribution device bracket 32 and reduce the space occupied by the power distribution device bracket 32.

Furthermore, as shown in FIG. 22a, FIG. 22b, FIG. 24, etc., a reinforcing rib 321a is provided on the power distribution device bracket 32, so that the strength of the power distribution device bracket 32 can be improved and the stability of the power distribution device 31 can be improved. In addition, the reinforcing rib 321a is located at the top 321 in an area that avoids the configuration of the power distribution device 31, thereby, for example, firmly fixing the power distribution device 31 on the power distribution device bracket 32. In this embodiment, there are a plurality of reinforcing ribs 321a extending in each of the front and back directions and in a straight line. It is understood that other forms of reinforcing ribs can be provided, such as reinforcing ribs extending in the left and right directions, or curved reinforcing ribs.

### Control Device and Related Structure

As shown in FIG. 3, FIG. 12 and FIG. 15a, the control device 41 of the battery management system (BMS) and the low-voltage harness 61 are configured in the gap S between the battery modules 20L and the battery modules 20R inside the housing 10.

As shown in FIG. 5, a plurality of control devices 41A, 41B and 41C (in the description herein, the plurality of control devices are collectively referred to as control device 41 when no distinction is made between the plurality of control devices) of the battery management system are disposed between the battery modules 20L and the battery modules 20R in the housing 10. The control devices 41A, 41B, and 41C are arranged in order from front to back. The control devices 41A, 41B, and 41C may be composed of electronic control units (ECUs). In this embodiment, the control devices 41A and 41B are battery information collectors (BICs) and the control device 41C is a battery management unit (BMU). These control devices 41A, 41B and 41C constitute a battery management system for intelligently managing and maintaining each battery module, preventing overcharging and overdischarging, extending the service life, monitoring the battery status, etc.

It will be understood that the number and form of the control devices described above are merely illustrative and do not constitute a limitation of the present invention.

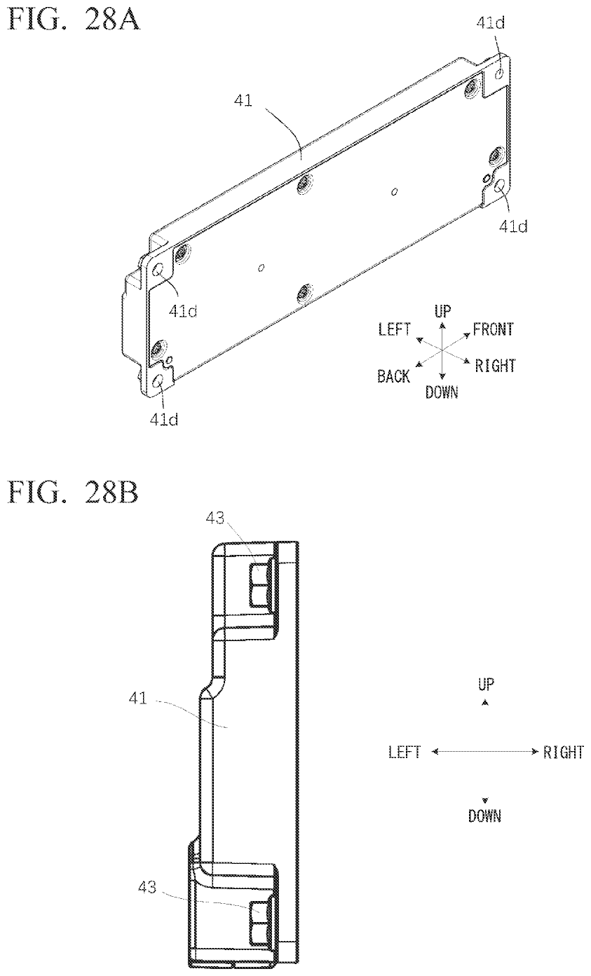

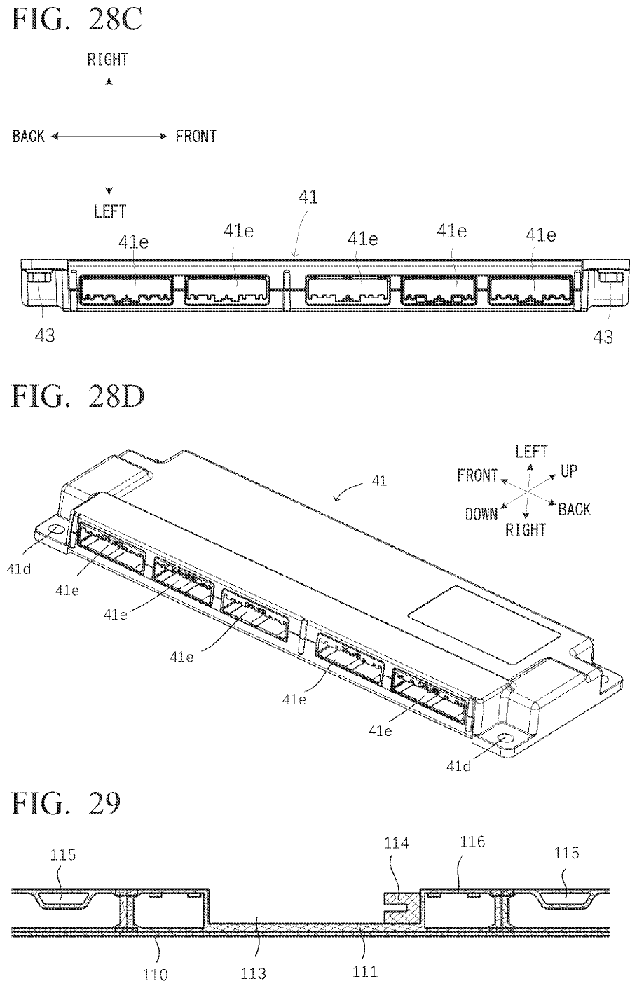

FIG. 28a is a schematic diagram of a three-dimensional structure of a control device in this embodiment; FIG. 28b is a schematic side view of the control device; FIG. 28c is a schematic bottom view of the control device; and FIG. 28d is another schematic diagram of a three-dimensional structure of the control device. As shown in FIG. 15a, FIG. 16, FIG. 17, FIG. 28a, FIG. 28b, FIG. 28c and FIG. 28d, the control device 41 is substantially rectangular in shape with a thickness direction substantially in line with the left and right directions, the long side configured in the front and rear directions, and the short side configured in the up and down directions.

Because the smallest size is in the thickness direction, followed by the short side direction, and the largest size is in the long side direction, it is possible to miniaturize the battery pack 100 by making the thickness direction consistent with the left and right directions, thereby reducing the size in the left and right directions of the gap S.

In addition, configuring the short side in the up and down directions enables the height of the control device 41 to be reduced compared to when the long side is configured in the up and down directions, thereby suppressing the size of the battery pack 100 in the up and down directions and facilitating miniaturization.

Further, since the gap S is long in size in the front and back directions (the direction in which the plurality of battery modules 20L or 20R are aligned), even though the long side of the control device 41 is configured in the front and back directions, it does not cause the battery pack 100 to increase in size in the front and back directions, facilitating miniaturization.

As shown in FIGS. 15a and 17, the control device 41 is mounted on the high-voltage harness bracket 112 via the control device bracket 42. In this way, the control device 41 is mounted using the high-voltage harness bracket 112 of the high-voltage harness 51, thereby enabling a simple and compact structure that facilitates miniaturization of the battery pack 100. As an example of the mounting method, in this embodiment, the control device 41 is fixed to the control device bracket 42 by bolts 43 as shown in FIG. 15a.

As shown in FIG. 15a, the control device bracket 42 comprises a main part 42a and a base part 42b. The main part 42a is provided vertically for mounting the control device 41, and the base part 42b is bent from the lower end of the main part 42a so as to extend in the left and right directions for mounting on the high-voltage harness bracket 112. For example, the base part 42b is fixed to the high-voltage harness bracket 112 by bolts which are not shown. It will be understood that the base part 42b may also be fixed to the high-voltage harness bracket by other means, such as by welding.

In this way, the control device bracket 42 overall has substantially an L shape (in this embodiment, an L shape viewed from the rear), thereby having the technical effect of taking up less space and improving the space utilization inside the battery pack 100. In addition, having a base part 42b extending from the lower end of the main part 42a in the left and right directions, it is possible to securely mount the control device bracket 42 on the high-voltage harness bracket 112.

As shown in FIGS. 28c and 28d, the control device 41 has a connector 41e, which is located in the lower part of the control device 41 (interface) facing downward. Alternatively, the control device 41 is configured with the connector 41e facing downward. A connector 65 that will be described later on the low-voltage harness 61 is mated to the connector 41e from below to collect voltage, temperature and other information from the battery module 20. With the connector 41e located in the lower part of the control device 41, it is possible to have a good waterproof effect. Specifically, since dew will form on the control device 41 and its surrounding area due to dew condensation inside the housing 10 as a result of heating and cooling of the battery module 20, it is understood that the dew will flow downward, and thus, by setting the connector 41e in the lower part of the control device 41 and making it face downward, it is possible to prevent water generated from dew from flowing into the connector 41e and causing corrosion and other problems of the connector 41e.

Here, the connector 41e facing downward does not necessarily mean that it faces strictly vertically downward, but it may be angled downward, with the connector 41e facing downward and at an angle of greater than or equal to 0 but less than or equal to 90 degrees from the horizontal direction. As other embodiments, the angle may also be greater than or equal to 0 but less than or equal to 10 degrees, or greater than or equal to 0 but less than or equal to 30 degrees, 45 degrees, or 60 degrees. It is understood that the closer the angle is to the horizontal direction, the better the waterproofing effect. Alternatively, the connector 41e may be at an angle of 0 degrees to the horizontal direction. In addition, in the example of FIG. 28c, the control device 41 has a plurality of connectors 41e, and it is understood that the number of connectors 41e may vary depending on the function of the control device 41.

Further, as shown in FIG. 15a, FIG. 17 and FIG. 21a, a harness fixing portion 42c is provided in the middle of the up and down directions of the main part 42a of the control device bracket 42 for fixing a branch wire portion 612 that will be described later of the low-voltage harness 61. Specifically, the harness fixing portion 42c extends from the middle in the up and down directions of the main part 42a to the front and back directions, and a through-hole in which an embedded portion of the ring bracket 44 on the branch wire portion 612 is embedded is provided thereon, thereby fixing the branch wire portion 612 to the harness fixing portion 42c.

In this way, on the one hand, since the branch wire portion 612 of the low-voltage harness 61 is fixed in the middle in the up and down directions of the main part 42a, it is possible to keep its position stable and keep its connection to the battery module 20 stable, so that the battery pack 100 has stable performance; on the other hand, since the control device bracket 42 is used to fix the low-voltage harness 61, it is possible to simplify the structure and make the structure compact, which facilitates the installation of the control device 41 and the low-voltage connection component 60 in a limited space, facilitating the miniaturization of the battery pack 100.

In this embodiment, the branch wire portions 612 among the plurality of branch wire portions 612 that are electrically connected to the battery modules 20R on the right side are fixed by the harness fixing section 42c.

As shown in FIG. 15a, etc., the control device bracket 42 (base part 42b) is fixed to the right side part of the high-voltage harness bracket 112, such that the control device 41 is configured substantially rightward from the middle in the gap S.

### Low-Voltage Connection Component and Related Structure

Referring to FIG. 3, FIG. 12 and FIG. 15a, the low-voltage connection component 60 is configured in the gap S between the battery modules 20L and the battery modules 20R inside the housing 10 as described above.

The low-voltage connection component 60 comprises a low-voltage harness 61 with a low-voltage harness bracket 62, etc. The low-voltage harness 61 is mounted on the base plate 11 by means of the low-voltage harness bracket 62 on the high-voltage harness bracket 112, and thereby is located above the high-voltage harness bracket 112. Since the low-voltage harness 61 is mounted on the high-voltage harness bracket 112 through the low-voltage harness bracket 62, i.e., the high-voltage harness bracket 112 of the high-voltage harness 51 is used to mount the low-voltage harness 61, it is thereby possible to make the structure simple and compact, which facilitates the miniaturization of the battery pack 100. Further, during assembly, the low-voltage harness 61 and the high-voltage harness 51, etc., can be mounted together and treated as a single unit, thereby enabling easy assembly.

As other embodiments, the low-voltage harness bracket 62 can also be mounted directly on the base plate 11.

As shown in FIG. 16, etc., the low-voltage connection component 60 is configured to the left of the control device 41 in the left and right directions. That is, the control device 41 is roughly configured from the middle to the right in the gap S, and the low-voltage connection component 60 is roughly arranged from the middle to the left in the gap S. In the left and right directions, the control device 41 is configured between the right battery modules 20R and the low-voltage connection component 60 (low-voltage harness 61), and the low-voltage connection component 60 is configured between the control device 41 and the left battery modules 20L. It will be understood that, as other embodiments, the left and right positions of the low-voltage connection component 60 and the control device 41 may be interchangeable.

Alternatively, as shown in FIG. 12, FIG. 16, etc., the low-voltage connection component 60 is configured at a lower position than the control device 41 in the up and down directions. That is, in this embodiment, the low-voltage connection component 60 is configured on the lower left side of the control device 41. Additionally, referring to FIG. 12, FIG. 16, etc., the low-voltage harness 61 has a bent portion, which is bent to the right (or convex to the right), near the reinforcing member 72 of the reinforcing component 70, so that this part of the low-voltage harness 61 is offset to the right relative to its adjacent part to avoid interference with the reinforcing member 72. Thus, for example, it is possible to obtain the technical effect of avoiding interference between the reinforcing member 72 and the low-voltage harness 61 and avoiding wear of the reinforcing member 72 by the low-voltage harness 61.

In addition, in this embodiment, the high-voltage connection component 50 is configured in the holding portion 113 and the low-voltage connection component 60 is configured outside the holding portion 113, thereby, for example, making use of the limited space in the base plate 11 to improve the safety of the battery pack 100 as efficiently as possible.

As shown in FIG. 18, etc., the low-voltage harness 61 comprises a main wire portion 611 and a plurality of branch wire portions 612. The main wire portion 611 extends in front and back directions. The plurality of branch wire portions 612 are electrically connected to the main wire portion 611. Specifically, the main wire portion 611 and the plurality of branch wire portions 612 are arranged between the control device 41 and the battery module 20, and the connector 65 is arranged below the control device 41. In this way, there is more space to set the connection between the branch wire portions 612 and the connector 65, thereby preventing the branch wire portions 612 from being easily broken and prolonging the life of the branch wire portions 612. In addition, because only the space for setting the connector is required under the control device 41 and the branch wire portions 612 do not occupy the space under the control device 41, the height of the control device 41 can be reduced, and the housing of the battery pack has a smaller height dimension for housing the control device 41, which contributes to the miniaturization of the battery pack.

Here, the connector 65 is used to connect the control device 41; and the connector 66 is used to connect the battery module 20. Since the wiring port 20c of the battery module 20 is set in the upper part of the battery module 20 at a higher position, the branch wire portion 612 with the connector 66 extends upward to enable the connector 66 to be plugged into the wiring port 20c of the battery module 20.

The connector 65 is supported on the low-voltage harness bracket 62 so that it can remain at a stable position.

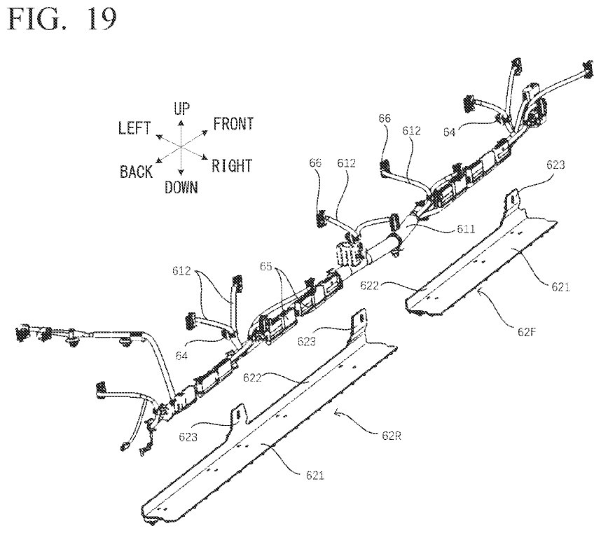

As shown in FIG. 18, FIG. 19, etc., there are two low-voltage harness brackets 62, namely, a low-voltage harness bracket 62F and a low-voltage harness bracket 62R, which are arranged in front and back directions. In particular, the low-voltage harness bracket 62F is configured in front of the reinforcing component 70 and the low-voltage harness bracket 62R is configured at the rear of the reinforcing component 70. The low-voltage harness bracket 62F and the low-voltage harness bracket 62R are spaced apart to avoid the reinforcing component 70, preventing the reinforcing component 70 from causing a larger opening 72e (FIG. 12) and thereby causing a reduction in strength when avoiding the low-voltage harness bracket 62. The rearward low-voltage harness bracket 62R is relatively long and corresponds to part of the low-voltage harness 61 of both control devices 41; the forward low-voltage harness bracket 62F is relatively short and corresponds to part of the low-voltage harness 61 of one control device 41. Here, “F” and “R” in the attached markings “62F” and “62R” are used to indicate “front” and “rear”, respectively, and both are collectively referred to as the low-voltage harness bracket 62 when no distinction is made between front and rear.

The low-voltage harness bracket 62 comprises a main part 621 and a wire harness fixing portion 623. The main part 621 is in the form of a plate and is arranged substantially horizontally to support the main wire portion 611 and connector 65 of the low-voltage harness 61. The wire harness fixing portion 623 extends upwards by bending from the left and right ends of the main part 621 (in this embodiment, from the left end), and is used to fix part of the multiple branch wire portions 612 of the low-voltage harness 61. Specifically, the wire harness fixing portion 623 is used to fix the branch wire portions 612 of the plurality of branch wire portions 612 that are electrically connected to the battery modules on the left side. Regarding the specific fixing method, for example, a through hole can be set on the wire harness fixing portion 623, and an insertion part of the ring bracket 64 sleeved on the branch wire portion 612 can be embedded in the through hole, thereby fixing the branch wire portion 612 on the wire harness fixing portion 623.

In this way, the branch wire portion 612 of the low-voltage harness 61 is fixed at the upwardly extending position of the wire harness fixing portion 623, thus it is possible to keep the position of the branch wire portions 612 stable and keep its connection to the battery module 20 stable, making performance of the battery pack 100 stable.

Referring to FIG. 16, a raised part 112b is provided on the high-voltage harness bracket 112 that rises upward and is located in the up and down directions opposite the gap between the forward low-voltage harness bracket 62 and the rearward low-voltage harness bracket 62. The portion between the forward low-voltage harness bracket 62 and the rearward low-voltage harness bracket 62 of the main part 611 of the low-voltage harness 61 is supported by the raised part 112b, and is also fixed to the raised part 112b. Specifically, a through hole is provided on the raised part 112b, and an insertion part of the ring bracket 63 sleeved in the middle of the main part 611 (specifically the bending part) is embedded in the through hole, thereby fixing the main part 611 on the high-voltage harness bracket 112.

In this way, since the main wire portion 611 is supported by the raised part 112b of the high-voltage harness bracket 112 at a position where the low-voltage harness bracket 62 cannot be supported, the position of the low-voltage harness 61 (main wire portion 611) is effectively kept stable, and the safety and performance stability of the battery pack 100 are improved.

The ring brackets 44, 63, and 64 may be made of a metal or may be made of a plastic.

Alternatively, as other embodiments, the low-voltage harness 61 may be fixed to the high voltage harness bracket 112.

### Reinforcement Components and Related Structures

As shown in FIGS. 6 to 8, a reinforcing component 70 is provided within the housing 10, is configured in the middle of the front and back directions within the housing 10, and extends in the left and right directions, mainly for strengthening the housing 10 in the left and right directions. For example, when the vehicle 200 is subjected to a lateral impact, the reinforcing component 70 can resist the lateral impact force, suppressing the deformation of the housing 10, as well as damage caused by the impact to the battery module 20 inside the housing 10. In this embodiment, one reinforcing component 70 is provided, however, as other embodiments, a plurality of reinforcing components spaced apart and arranged in the front and back directions may be provided. In this embodiment, the reinforcing component 70 may also be referred to as a beam.

In this embodiment, the reinforcing component 70 is supported on the upper surface of the base plate 11, i.e. is located above the base plate 11. Thus, the reinforcing component 70 can be prevented from interfering with the holding portion 113 or the coolant channels 115 in the base plate 11. Compared with the structure in which the reinforcing parts are provided below the plate 116 or at approximately the same height, it is not necessary to provide an avoidance part on the reinforcing component 70 or on the holding portion 113 and the coolant passage 115 to avoid interference, thus making it possible to simplify the structure and reduce the manufacturing cost. Also, as described above, in this embodiment, the holding portion 113 is formed in the shape of a long slot extending in the front and back directions, and the reinforcing component 70 extends in the left and right directions, and thereby the reinforcing component 70 extends crosswise with the holding portion 113. Alternatively, the reinforcing component 70 may be said to extend in the extending direction of the plate 116 or along the upper surface of the plate 116.

FIG. 10 is a schematic diagram of the three-dimensional structure of the reinforcing component involved in this embodiment. As shown in FIGS. 6 to 8 and FIGS. 10 to 12, the reinforcing component 70 comprises a first connection component 71, a second connection component 73, and a reinforcing member 72. The first connection component 71 is supported on the base plate 11 of the housing 10 and extends from the left side plate 12 toward the middle in the left and right directions. The second connection part 73 is supported on the base plate 11 and extends from the right side plate 12 towards the middle in the right and left directions. A spacer is provided between the first connection component 71 and the second connection component 73. The reinforcing member 72 extends in the left and right directions and is connected between the first connection component 71 and the second connection component 73, having an upwardly convex arch structure to avoid the low-voltage harness 61, etc., configured in the gap S. One end of each of the first connection component 71 and the second connection component 73 is connected to the reinforcing member 72, and the other end of each may be connected to the side plate 12 of the housing 10.

By providing the arch-shaped reinforcing member 72, for example, it is possible to ensure the strength of the reinforcing component 70 based on avoiding the low-voltage harness 61, etc., compared to providing openings in the reinforcing member to avoid the low-voltage harness.

As shown in FIG. 12, the reinforcing member 72 has an overall generally inverted U shape and comprises an arch portion 72a, a vertical portion 72b, and a fixed portion 72c. The arch portion 72a corresponds to the middle portion of the U shape, and its upper and lower surfaces are curved upward and arched upward so as to have an arch shape. There are two vertical parts 72b that extend downward from each of the left and right ends of the arched portion 72a opposite to the first connection component 71 and the second connection component 73 in the left and right directions. That is, the vertical portions 72b coincide with the first connection component 71 and the second connection component 73 when viewed in the left and right directions. In this way, when the vehicle is subjected to a lateral collision, for example, the vertical portions 72b abut the first connection component 71 and the second connection member 73 in the left and right directions, and reliably transmit the force from one of the first connection component 71 and the second connection component 73 to the arch portion 72a above, and from the arch portion 72a to the other of the first connection component 71 and the second connection component 73, thereby effectively increasing the strength of the reinforcing component 70 as a whole, i.e., increasing the resistance of the reinforcing component 70 against external forces.

An opening 72e is formed by the inner surfaces of the arch portion 72a and the two vertical portions 72b, in which the low-voltage harness 61 and the raised portion 112b of the high-voltage harness holder 112 are accommodated.

There are two fixing portions 72c, which protrude from the connection position of the arch portion 72a and the vertical portion 72b to the outer part in the left and right directions and are fixed to the first connection component 71 and the second connection component 73 by means of bolts 16d. In this way, when the vehicle is subjected to a lateral collision, for example, the force can be effectively transmitted to the arch portion 72a by the first connection component 71 or the second connection component 73, and the overall strength of the reinforcing component 70 can be effectively improved, i.e., the resistance of the reinforcing component 70 to external forces can be improved.

The bolt 16d is provided vertically through the fixing portion 72c, the first connection component 71, the second connection component 73 and the plate 116, and the penetrating lower end is screwed with a nut 16e, so that not only is the fixing portion 72c fixed to the first connection component 71 and the second connection component 73, but also the first connection component 71 and the second connection component 73 are fixed to the base plate 11. In this way, the reinforcing member 72 is fixed to the first connection component 71 and the second connection component 73 using a structure by which the first connection component 71 and the second connection component 73 are fixed to the base plate 11, thereby simplifying the structure and reducing the cost, and also making the structure compact and conducive to the miniaturization of the battery pack 100.

In addition, a plurality of grooves 72d are provided on the arch portion 72a and the vertical portion 72b, specifically, the grooves 72d are triangular recesses. Thus, the weight of the reinforcing member 72 is reduced while the strength of the reinforcing member 72 is guaranteed.

In this embodiment, as shown in FIG. 12, the lower end 72b1 of the vertical portion 72b extends downward into the holding portion 113 so that, for example, when the vehicle is subjected to a lateral impact, the holding portion 113 is deformed by contraction in the left and right directions, at which time the left and right side walls of the holding portion 113 (i.e., the left and right side walls of the recess) contact the lower end 72b1 of the vertical portion 72b, so that the reinforcing member 72 is used to withstand the external force in the left and right directions, thereby increasing the strength of the base plate 11 in the left and right directions. The base plate 11 is strengthened in the left and right directions by the reinforcing member 72 to withstand the external force in the left and right directions.

In addition, in this embodiment, the side portion of this lower end 72b1 is in contact with the left and right edges of the holding portion 113 (edges of the opening 116a of the plate 116, FIG. 15b), thereby reliably improving the strength of the base plate 11 in the left and right directions. Here, the edges of the openings 116a are part of the sidewalls of the holding portion 113, and it is understood that the lower end 72b1 of the vertical portion 72b can be further extended downward while increasing the contact area or contactable area with the sidewalls of the holding portion 113 to further improve the strength of the base plate 11.

Further, as described above, the reinforcing member 72 is pressed on the high-voltage harness bracket 112, specifically the lower end 72b1 of the vertical portion 72b of the reinforcing member 72 is pressed in the middle of the lengthwise direction of the main part 112a of the high-voltage harness bracket 112, so that the displacement or deformation of the high-voltage harness bracket 112 in the up and down directions can be suppressed. Further, as described above, the reinforcing member 72 is pressed on the main part 112a of the high-voltage harness bracket 112 by the cushioning members 74 (FIG. 21c), and specifically the lower ends 72b1 of the vertical portion 72b are pressed on the main part 112a of the high-voltage harness bracket 112 by the cushioning members 74, so that damage to the high-voltage harness bracket 112 can be suppressed.

In this embodiment, the reinforcing member 72, the first connection component 71 and the second connection component 73 are molded separately, however, the invention is not limited to this, for example, the reinforcing member 72 can also be molded in one piece with the first connection component 71 and/or the second connection component 73.

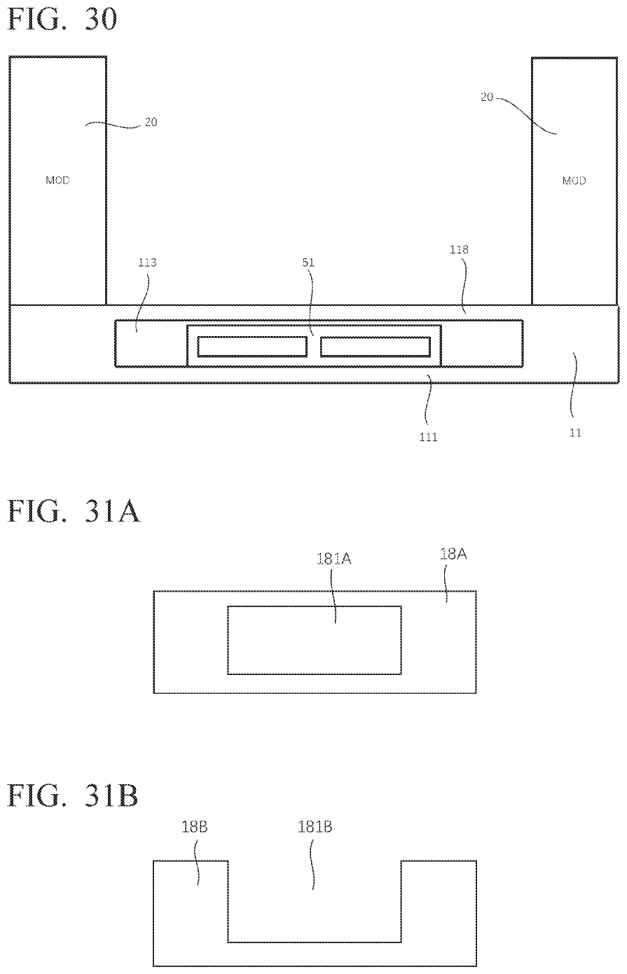

FIG. 30 is a schematic diagram of the structure of the battery pack involved in another embodiment of the present invention. The difference between the embodiment shown in FIG. 30 and the above embodiment is that, in the above embodiment, an opening 116a is provided in the plate 116, whereas in FIG. 30, instead of the plate 116, the structure is provided with a plate 118 (an example of the first plate), which is approximately equal in size to the plate 111 in the left and right directions, does not have an opening in the position opposite the holding portion 113 and forms the top of the holding portion 113. Further, the holding portion 113 runs through the front and/or rear portions of the base plate 11, i.e., in this embodiment, the holding portion 113 is formed in the form of an elongated hole extending in the front and back directions. During assembly, the high-voltage harness 51 can be inserted into the holding portion 113 from the front or the rear through the opening of the holding portion 113 (long hole). Also, in this embodiment, the high-voltage harness bracket 112 in the above embodiment is omitted. Furthermore, in this embodiment, in the state where the high-voltage harness 51 is inserted into the holding portion 113, the high-voltage harness 51 has a portion that is horizontally exposed outside of the holding portion 113, and this portion can be fixed to the base plate 11 to fix the high-voltage harness 51 to the base plate 11.

Some examples of a base plate and a holding portion in the base plate are illustrated in FIGS. 31a to 31f by way of partial cross-sectional diagrams. In FIG. 31a, the housing 10 of the battery pack 100 has a base plate 18A, in which a holding portion 181A composed of a cavity is provided. In addition, in this structure, the base plate 18A has a thicker plate thickness (larger than the dimension of the holding portion 181B in the up and down directions) or, alternatively, a thickened portion can be provided on the base plate 18A, with a thickness greater than that of the portion adjacent thereto, and the holding portion 181A can be provided in the thickened portion.

In FIG. 31b, the housing 10 has a base plate 18B, and there is a groove on the upper surface of the base plate 18B, which forms the holding portion 181B. In this structure, the base plate 18B has a thicker plate thickness (larger than the dimension of the holding portion 181B in the up and down directions), or a thickened portion can be provided on the base plate 18B, with a thickness greater than that of the portion adjacent thereto, and the holding portion 181B can be provided in the thickened portion. Similarly, a recess (not shown) is provided on the lower surface of the base plate 18B, and the recess constitutes the holding portion.

In FIG. 31c, the housing 10 has a base plate 18C, and the base plate 18C has a plate 182C and a plate 183C, which are arranged at relative positions in the up and down directions and separated by intervals. A through opening 182C1 is provided in the upper plate 182C, and a holding portion 181C is formed between the plate 182C and the plate 183C. The high-voltage connection component 50 can be configured in the holding portion 181C through the opening 182C1. The high-voltage connection component 50 can be configured in the holding portion 181C through the opening 182C1. With such a structure, the dimension in the left and right directions of the holding portion 181C can be larger and can accommodate a high-voltage connection component with a larger dimension in the left and right directions. Alternatively, the dimension in the left and right directions of the opening 182C1 may be smaller than that of the high-voltage connection component 50. Similarly, a through opening (not shown) is provided in the lower plate 183C to form a holding portion between the plate 182C and the plate 183C.

In FIG. 31d, the housing 10 has a base plate 18D, and the base plate 18D has plates 182D and 183D, which are arranged at relative positions in the up and down directions and separated by intervals. The upper surface of the upper plate 182D is provided with a recess, which is raised when viewed from one side of the lower surface of the plate 182D, from which the holding portion 181D is formed. With such a structure, the recess (raised) can be considered as a reinforcing rib (similar to a pressed rib) on the plate 182D, and thus the strength of the plate 182D and the base plate 18D can be improved.

Further, as shown in FIG. 31d, the holding portion 181D (recess) has an opening 182D1, partitioning walls 182D and a bottom wall 182D3. The opening 182D1 is set on the plate 182D, the partitioning walls 182D2 extend from the left and right edges of the opening 182D1 toward the plate 183D, that is, they extend downward, and the bottom wall 182D3 is connected between the left and right partitioning walls 182D2.

In FIG. 31e, the housing 10 has a base plate 18E, and the base plate 18E has a plate 182E and a plate 183E, which are arranged at relative positions in the up and down directions and separated by intervals. The lower surface of plate 183E is provided with a recess, which is a projection when viewed from one side of the upper surface of the plate 183E, from which the holding portion 181E is formed. Furthermore, the projection may be spaced apart from plate 182E or may be in contact with the plate 182E.

In FIG. 31f, the housing 10 has a base plate 18F, and the base plate 18F has a plate 182F and a plate 183F, which are arranged at relative positions in the up and down directions and separated by intervals. The upper plate 182F is provided with a through opening 182F1, and the left and right edges of the opening 182F1 are provided with partitioning walls 182F2 extending downward, so that the holding portion 181F is formed from the opening 182F1 and partitioning walls 182F2, i.e., the holding portion 181F has an opening 182F1 and partitioning walls 182F2. The opening 182F1 is formed on the plate 182F, and the partitioning walls 182F2 define the left and right boundaries of the holding portion 181F. In this structure, the lower end of each of the partitioning walls 182F2 can be set to be in contact with the plate 183F to form a reliable support between the plate 182F and the plate 183F and improve the strength of the base plate 18F in the up and down directions. Likewise, an opening (not shown) is provided through the lower plate 183F, and partitioning walls extending upward are provided on the left and right edges of the opening, so that the holding portion is formed by the opening and the partitioning walls.

Alternatively, the lower end of the partitioning walls 182F2 may not be in contact with the plate 183F, and when the base plate 18F is subjected to a force in the up and down directions, the partitioning walls 182F2 support the plate 183F, thereby improving the strength of the base plate 18F.

In addition, the structure of FIG. 31f can be seen to be obtained by omitting the bottom wall of the holding portion 181E in FIG. 31e.

Compared with structure in FIGS. 31a and 31b, the structure shown in FIGS. 31d to 31f can achieve a technical effect of reducing the weight of the base plate while taking into account the strength of the base plate.

A method of assembling the battery pack of the embodiment shown in FIGS. 2 to 29 is described below.

The assembly method comprises the following steps:
S1, fixing the battery module 20 to the base plate 11;
S2, fixing the high-voltage harness 51, the low-voltage harness 61 and the control device 41 to the high-voltage harness bracket 112, thereby forming a single unit (referred to as a first assembly);
S3, fixing the first assembly to the base plate 11; and
S4, fixing the upper cover 13 relative to the base plate 11 to form the battery pack 100.

Using the method as described above, the high-voltage harness 51, the low-voltage harness 61 and the control device 41 are fixed to the high-voltage harness bracket 112 and treated together as the first assembly, thereby making the battery pack 100 easy and convenient to assemble.

The order of S1 and S2 mentioned above is not limited. S1 can be executed first and S2 can be executed later. They can also be executed in reverse.

Optionally, said S2 comprises: fixing the control device 41 to the high-voltage harness bracket 112 via the control device bracket 42; and fixing the low-voltage harness 61 to the high-voltage harness bracket 112 via the low-voltage harness bracket 62.

The control device 41 may be mounted first on the control device bracket 42 and then on the high-voltage harness bracket 112, or the control device 41 bracket may be mounted first on the high-voltage harness bracket 112 and then on the control device 41. The same applies to the low-voltage harness 61 and the low-voltage harness bracket 62.

Embodiments of the present invention provide a battery pack 100 and a vehicle 200 having the battery pack 100. The battery pack 100 comprises: a housing 10 comprising a base plate 11 with a holding portion 113 in the base plate 11; a battery module 20 arranged above the base plate 11; and a high voltage connection component 50 which is electrically connected to the battery module 20 and is housed in the holding portion 113.

The power distribution device 31 is electrically connected to the connector 52 and the plurality of battery modules 20 and electrically connected to the connector 53 and the plurality of battery modules 20. The power distribution device 31 is disposed above a single battery module 20 and disposed closer to the connector 53 at the rear than to the connector 52 at the front.

Further, the battery module 20 comprises left side battery modules 20L and right side battery modules 20R, with a gap S between the left side battery modules 20L and the right side battery modules 20R. The control device 41 is provided in the gap S. The low-voltage connection component 60, which is electrically connected to the battery modules 20L, 20R and the control device 41, is also provided in the gap S. The low-voltage connection component 60 is located between the control device 41 and the battery modules 20R and is located below (i.e., diagonally below) the control device 41.

In addition, a reinforcing component 70 is provided above the base plate 11, and extends in the left and right directions as a whole. The reinforcing component 70 comprises a reinforcing member 72, a first connection component 71 and a second connection component 73. The reinforcing member 72 comprises an arch portion 72a, which is set in the gap S and arched upward, and the low-voltage connection component 60 passes through the inner side of the arch portion 72a. One end of each of the first connection component 71 and the second connection component 73 is connected to the reinforcing member 72, and the other end of each may be connected to the side plate 12 of the housing 10.

With the structure of the present embodiment, for example, when the vehicle is subjected to a lateral collision, the battery pack 100 is deformed and the battery module 20 moves in the extending direction of the base plate 11, however, since the high-voltage connection component 50 is configured in the base plate 11 below the battery module 20, the battery module 20 is unlikely to hit the high-voltage connection component 50, and thereby deformation, breakage, etc. of the high-voltage connection component 50 are suppressed. Thus, the safety and reliability of the battery pack 100 are improved.

In addition, setting the power distribution device 31 above the single-side battery module 20 not only improves the convenience of installation of the power distribution device 31, but also improves the stability of the power distribution device 31, and reduces the overall space occupied by the power distribution device 31 and improves the energy density of the battery pack 100 (the middle gap is not occupied, which minimizes the width of the battery pack).

Further, the power distribution unit 31 is set close to the connector 53, which can reduce the wire length of the high-voltage connection component 50 and reduce the cost. In addition, the power distribution device 31 is set close to the connector 53 at the rear of the battery pack, so that the front portion of the housing 10 of the battery pack does not need to be provided with a raised portion to accommodate the power distribution device 31, which in turn allows more space in the cabin corresponding to the location of the battery pack to accommodate the feet of passengers.

Also, setting the control device 41 vertically in the gap S makes reasonable use of the space of the housing 10, reduces the overall space occupied by the control device 41 in the battery pack 100, improves the energy density of the battery pack 100, and also facilitates assembly.

In addition, the reinforcing component 70 can improve the strength of the housing of the battery pack 100, and the arch portion 72a can inhibit the reduction of the strength of the reinforcing component 70, spread the force effectively, and better deform and buffer when the battery pack 100 is impacted.

The terms “first, second, third, etc.” or module A, module B, module C, and similar terms herein are used only to distinguish similar objects and do not represent a specific ordering of objects, and it is understood that specific orders or sequences may be interchanged where permitted so that embodiments of the present application described herein can be implemented in an order other than that illustrated or described herein.

The term “comprises” as used herein should not be construed as limiting to what is listed thereafter, and it does not exclude other components or steps. Accordingly, it should be interpreted as designating the presence of said feature, whole, step, or component mentioned, but does not preclude the presence or addition of one or more other features, whole, steps, or components and groups thereof. Thus, the expression “apparatus comprising apparatus A and B” should not be limited to an apparatus comprising only parts A and B.

References in this specification to “an embodiment” or “embodiments” mean that the particular feature, structure or characteristic described in conjunction with that embodiment is included in at least one embodiment of the present invention. Thus, the terms “in one embodiment” or “in an embodiment” appearing throughout this specification do not necessarily refer to the same embodiment, but may refer to the same embodiment. In addition, in one or more embodiments, the particular features, structures, or characteristics can be combined in any suitable manner, as would be apparent from the present disclosure to one of ordinary skill in the art.

Further, the foregoing is only a preferred embodiment of the present application and the technical principles employed. It will be understood by those of skill in the art that the present invention is not limited to the particular embodiments described herein, but is capable of various obvious variations, readjustments, and substitutions without departing from the scope of protection of the present invention. Therefore, although the present application is described in some detail by the above embodiments, the present invention is not limited to the above embodiments, but may include more other equivalent embodiments without departing from the conception of the present invention, all of which fall within the scope of protection of the present invention.

What is claimed is:

1. A battery pack, comprising:
a housing comprising a base plate, said base plate being provided with a holding portion;
a battery module arranged above said base plate; and
an electrical connection component, which is electrically connected to said battery module and is housed in said holding portion.

2. The battery pack according to claim 1, wherein some or all of said electrical connection component is located below the horizontal plane where the lowest point of said battery module is located.

3. The battery pack according to claim 1, wherein a coolant channel is provided in said base plate.

4. The battery pack according to claim 3, wherein, in said base plate, viewed in the up and down directions, said coolant channel is configured at a position overlapped with said battery module, and said holding portion is configured at a position staggered from said battery module.

5. The battery pack according to claim 1, wherein said electrical connection component comprises a high-voltage connection component.

6. The battery pack according to claim 5, wherein said high-voltage connection component comprises a high-voltage harness, and said high-voltage harness is flat in a cross section, and is accommodated in said holding portion such that its thickness direction is roughly consistent with the thickness direction of said base plate.

7. The battery pack according to claim 5, wherein said high-voltage connection component is in a long shape, extending from one end of said base plate to the other end.

8. The battery pack according to claim 5, wherein said high-voltage connection component comprises a high-voltage harness and a high-voltage harness bracket, said base plate is provided with an opening, said high-voltage harness bracket covers said opening, forming the top of said holding portion, and said high-voltage harness is arranged below said high-voltage harness bracket.

9. The battery pack according to claim 8, wherein the lowest point of said high-voltage harness bracket is located on a horizontal plane that is roughly the same as or lower than the upper surface of said base plate.

10. The battery pack according to claim 8, wherein the high-voltage harness comprises a cladding layer and a conductive component arranged within said cladding layer, and said cladding layer is fixed on said high-voltage harness bracket.

11. The battery pack according to claim 8, wherein the battery pack further comprises a low-voltage connection component electrically connected with said battery module, and said low-voltage connection component is arranged above said high-voltage harness bracket.

12. The battery pack according to claim 1, wherein a reinforcing component is provided above said base plate.

13. The battery pack according to claim 12, wherein said holding portion is in the shape of a long groove or a long hole, and said reinforcing component extends across said holding portion.

14. The battery pack according to claim 3, wherein the part of said coolant channel that is farther from the centerline of said base plate is located upstream along the liquid flow, while the part that is closer to the centerline of said base plate is located downstream along the liquid flow, wherein, the centerline extends in the extension direction of said base plate.

15. The battery pack according to claim 1, wherein said battery module comprises a plurality of first battery modules and a plurality of second battery modules,
said plurality of first battery modules are arranged in the first direction along the upper surface of said base plate, and said plurality of second battery modules are arranged in the first direction, both said first and second battery modules are spaced with a gap along the upper surface of said base plate in the second direction, and the second direction intersects with the first direction, and said holding portion is arranged in a position facing said gap.

16. The battery pack according to claim 1, wherein said holding portion comprises a cavity arranged within said base plate, or an opening formed on the upper or lower surface of said base plate.

17. The battery pack according to claim 16, wherein said base plate comprises a first plate and a second plate, said first plate is located above said second plate and arranged opposite to and separated from said second plate, and said opening is arranged on said first plate or said second plate.

18. The battery pack according to claim 17, wherein said holding portion further comprises a partitioning wall extending from the edge of said opening and extending from one of said first plate and said second plate to the other.

19. The battery pack according to claim 18, wherein said partitioning wall comprises a first partition wall and a second partition wall, and said first partitioning wall and said second partition wall are arranged at the edges of both sides of said opening, and
said holding portion also has a bottom wall, which is connected between said first partitioning wall and said second partitioning wall.

20. The battery pack according to claim 19, wherein said bottom wall contacts or is separated from the other of said first plate and said second plate.

21. A vehicle comprising a battery pack according to claim 1.
